(19) United States
(12) Patent Application Publication
(10) Pub. No.: US 2021/0261468 A1
(43) Pub. Date: Aug. 26, 2021

(54) CERAMIC PHOTORESIN FORMULATION

(71) Applicant: BASF SE, Ludwigshafen am Rhein (DE)

(72) Inventors: Elvira STESIKOVA, Wyandotte, MI (US); Mark Andrew GOETSCH, Wyandotte, MI (US); Nathan Dane WOOD, Wyandotte, MI (US); Sarah J. BOEHM, Iselin, NJ (US)

(21) Appl. No.: 17/252,592

(22) PCT Filed: Jun. 14, 2019
(86) PCT No.: PCT/US2019/037351

§ 371 Date: Dec. 15, 2020

Related U.S. Application Data
(60) Provisional application No. 62/815,885, filed on Mar. 8, 2019.
(60) Provisional application No. 62/685,686, filed on Jun. 15, 2018.

(51) Int. Cl. C04B 35/634; C04B 35/14; B28B 1/00; B33Y 70/10; B33Y 10/00; B33Y 40/10; B33Y 40/20

(52) U.S. Cl. CPC C04B 35/63424; C04B 35/14; B28B 1/001; B33Y 70/10; B33Y 10/00; C04B 2235/666; B33Y 40/20; C04B 2235/3248; C04B 2235/5436; C04B 2235/5445; B33Y 40/10

(57) ABSTRACT

Ceramic photoresin compositions include an ethylenically unsaturated UV curable composition and at least about 70 wt % of a ceramic composition and optionally a photoinitiator, a formulation additive, and/or UV absorbing agent. The composition may be useful for 3D printing applications.

### CROSS-REFERENCE TO RELATED APPLICATIONS

This application is an International Patent Application that claims the benefit of priority to U.S. Provisional Patent Application Nos. 62/815,885, filed Mar. 8, 2019, and 62/685,686, filed Jun. 15, 2018. The contents of these applications are incorporated herein by reference in their entirety.

### FIELD

The present disclosure generally relates to ceramic photoresin composition, and more specifically, to ceramic photoresin compositions suitable for use in 3D (three-dimensional) printing including utilizing digital light processing techniques. In some embodiments, the present disclosure provides ceramic photoresin composition having improved functionality for producing ceramic articles. The compositions may be advantageous for use in large format printers as well as small format printers.

### BACKGROUND

Additive manufacturing, also referred to as 3D printing provides the promise of creativity, ingenuity and novel achievements with respect to design and manufacturing. The technology is attractive in that it enables users to design and produce articles having a high level of complexity with pinpoint accuracy. Although the technology has been successful in inspiring users to create a variety of articles, the output has generally been limited to prototypes, replacement parts and trinkets. Often, the resulting ceramic articles produced by additive manufacturing are fragile, display low resolution, and are expensive to produce at a micro or macro level. Other issues associated with 3D printed materials include low environmental stability resulting in yellowing, low resistance to moisture and solvents contributing to object swelling and plasticization.

One significant drawback of currently available ceramic photoresin compositions is overwhelming light scatter and deep light penetration during cure, which yields lower accuracy and precision of the built parts. Additional problems include poor stability against sedimentation and poor layer-to-layer adhesion leading to delamination. There is a need for improved compositions having better control of UV light penetration, reduced sedimentation, layer-to-layer adhesion, and print accuracy.

Accordingly, there remains an opportunity to provide improved ceramic photoresin composition materials, such as resins, for use in connection with additive manufacturing and/or 3D printing. There also remains an opportunity to provide improved materials that enable the production of small and large format objects. Furthermore, there remains an opportunity to provide novel and productive compositions that are cost-effective and have improved utility and enhanced material functionality.

### SUMMARY

In one aspect, the present technology provides ceramic photoresin composition including an ethylenically unsaturated UV curable composition and at least about 70 wt % of a ceramic composition, based on the total composition. In any embodiment, the composition may be a 3D printing composition. In another aspect, the present technology provides methods for making the ceramic photoresin composition and methods for making 3D printed articles therefrom.

Articles (e.g., 3D printed articles) produced using the ceramic photoresin composition may have improved properties including, but not limited to, improved stability against sedimentation, relatively low viscosity at high ceramic loading, good layer-to-layer adhesion, reduced overcuring, reduced cracking, appropriate density and porosity in the brown state (i.e. after sintering), and/or more precise 3D printed articles. For example, ceramic photoresin composition of the present technology may enable the production of articles having a desired surface resolution below approximately 100 μm. Articles for manufacture using the ceramic photoresin compositions include ceramic molds, cores and parts for investment casting and other applications including manufacturing of replacement parts for aerospace, dental, electronics and consumer applications.

### BRIEF DESCRIPTION OF THE DRAWINGS

FIG. 1 is a graph illustrating the ceramic content (wt %) at different tower heights (inches) of the 3D printed towers for Formula A, according to the Examples.

FIG. 2 is a graph illustrating the ceramic content (wt %) at different tower heights (inches) of the 3D printed towers for Formula B, according to the Examples.

FIG. 3 is a graph illustrating the ceramic content (wt %) at different tower heights (inches) of the 3D printed towers for Formula C, according to the Examples.

FIG. 4 is a photograph illustrating the layer-to-layer adhesion of Formulas B, C, and D, according to the Examples.

FIG. 5 is a graph of the depth of cure (Dₚ, mm) compared to the concentration (wt %) of the UV absorber in the formulation, according to the Examples.

FIGS. 6A and 6B are photographs illustrating the addition of a UV absorber upon curing. FIG. 6A illustrates 3D printed articles made from a formulation without a UV absorber and FIG. 6B illustrates similar articles made from a formulation with a UV absorber, according to the Examples.

FIG. 7 is a scatter plot illustrating the depth of cure (Dₚ, mm) of formulations containing a variety of UV absorbers at varying concentrations (wt %), according to the Examples.

FIG. 8 is a graph illustrating the storage modulus (Pa) for cured resin compositions 9-1, 9-2, and 9-4 at varying UV cure dosages (mJ/cm²), according to the Examples.

FIG. 9 is a graph illustrating the storage modulus (Pa) for cured resin compositions 9-4 and 9-5 at varying UV cure dosages (mJ/cm²), according to the Examples.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, “alkyl” or “alkane” groups include straight chain and branched alkyl groups having from 1 to about 20 carbon atoms, and typically from 1 to 12 carbons or, in some embodiments, from 1 to 8 or 1 to 6 carbon atoms. As employed herein, “alkyl groups” include cycloalkyl groups as defined below. Alkyl groups may be substituted or unsubstituted. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, isobutyl, sec-butyl, t-butyl, neopentyl, and isopentyl groups. Representative substituted alkyl groups may be substituted one or more times with, for example, amino, thio, hydroxy, cyano, alkoxy, and/or halo groups such as F, Cl, Br, and I groups. As used herein the term haloalkyl is an alkyl group having one or more halo groups. In some embodiments, haloalkyl refers to a per-haloalkyl group. In general, alkyl groups may include in addition to those listed above, but are not limited to, 2-pentyl, 2-methylbutyl, 3-methylbutyl, 1,2-dimethylpropyl, 1,1-dimethylpropyl, 2,2-dimethylpropyl, 1-ethylpropyl, 2-hexyl, 2-methylpentyl, 3-methylpentyl, 4-methylpentyl, 1,2-dimethylbutyl, 1,3-dimethylbutyl, 2,3-dimethylbutyl, 1,1-dimethylbutyl, 2,2-dimethylbutyl, 3,3-dimethylbutyl, 1,1,2-trimethylpropyl, 1,2,2-trimethylpropyl, 1-ethylbutyl, 2-ethylbutyl, 1-ethyl-2-methylpropyl, 2-heptyl, 3-heptyl, 2-ethylpentyl, 1-propylbutyl, 2-ethylhexyl, 2-propylheptyl, 1,1,3,3-tetramethylbutyl, nonyl, decyl, n-undecyl, n-dodecyl, n-tridecyl, iso-tridecyl, n-tetradecyl, n-hexadecyl, n-octadecyl, n-eicosyl, and the like.

Groups described herein having two or more points of attachment (i.e., divalent, trivalent, or polyvalent) within the compound of the present technology are designated by use of the suffix, “ene.” For example, divalent alkyl groups are alkylene groups, divalent aryl groups are arylene groups, divalent heteroaryl groups are divalent heteroarylene groups, and so forth. Substituted groups having a single point of attachment to the compound of the present technology are not referred to using the “ene” designation.

As used herein, “alkylene” refers to a divalent alkyl group, typically having from 2 to 20 carbon atoms, or from 2 to 12 carbon atoms, or in some embodiments, from 2 to 8 carbon atoms. Alkylene groups may be substituted or unsubstituted. Examples of straight chain alkylene groups include methylene, ethylene, n-propylene, n-butylene, n-pentylene n-hexylene, n-heptylene, and n-octylene groups. Representative alkyl groups may be substituted one or more times with, for example, amino, thio, hydroxyl, cyano, alkoxy, and/or halo groups such as F, Cl, Br, and I.

In general, the term “substituted,” unless specifically defined differently, refers to an alkyl, alkenyl, alkynyl, aryl, or ether group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like. For some groups, substituted may provide for attachment of an alkyl group to another defined group, such as a cycloalkyl group.

As used herein, the term (meth)acrylic or (meth)acrylate refers to acrylic or methacrylic acid, esters of acrylic or methacrylic acid, and salts, amides, and other suitable derivatives of acrylic or methacrylic acid, and mixtures thereof.

As used herein, the term “acrylic-containing group” or “methacrylate-containing group” refers to a compound that has a polymerizable acrylate or methacrylate group.

As used herein, the term “additive manufacturing” refers to a process by which digital 3D design data is used to build up an article in layers by depositing material.

As used herein, the term “3D printing” refers to any of various processes in which material is joined or solidified under computer control to create a three-dimensional article, with material being added together (cured or molded together). Unlike material removed from a stock in conventional machining processes, 3D printing builds a three-dimensional article using digital model data from a 3D model or another electronic data source such as computer-aided design (CAD) model or Additive Manufacturing File (AMF), usually by successively adding material layer by layer. 3D printing is associated with both rapid prototyping and additive manufacturing (AM). 3D printed articles can be of almost any shape or geometry. As used herein, 3D printing includes stereolithography (SLA), digital light processing (DLP), and vat photo polymerization (e.g., continuous liquid interface production (CLIP)). In any embodiment, the 3D printed article may be produced by any means known to a person of skill in the art including loading data into a computer that controls a light source that traces a pattern or projects an image of a cross section through a liquid radiation curable resin composition in a vat, solidifying a thin layer of the resin composition corresponding to the cross section. The solidified layer is recoated with the liquid resin composition and the light source traces another cross section or projects an image of a layer or its parts to harden another layer of the resin composition adjacent to the previous layer (e.g., on top or for underneath vat photo polymerization including SLA and DLP). The process is repeated layer by layer until the 3D article is completed. When initially formed, the 3D article is, in general, fully or partially cured, and is called a “green model.” In any embodiment, the green model may be manipulated through post-processing steps including post-printing electromagnetic radiation, sonication, vibration, washing, cleaning, debris management, support removal, post curing, baking, sintering, annealing, or any combination of two or more thereof. Various light sources may be used in 3D printing including, but not limited to, an UV light (e.g., LED or a light bulb), a laser, and/or a digital light projector (DLP) (i.e., image projection).

One significant drawback of the currently available ceramic photoresin compositions is an overwhelming amount of light scattering during cure and deep light penetration yields articles with lower accuracy and precision. Additional problems include poor stability against sedimentation and poor layer-to-layer adhesion leading to delamination. Currently available techniques often yield parts that suffer from over-curing including parts that are prone to easy fracturing/breakage, parts that display cracks, and other evidence of part instability.

A challenge in developing the compositions for 3D printing is that many of the above requirements are either interdependent or mutually opposing. For instance, a ceramic photoresin composition with high ceramic loading typically results in high viscosity and stability against sedimentation, however, having high viscosity provides poor flowability.

A challenge unique in developing ceramic compositions for 3D printing is that photoinitiated radical polymerization is a common mechanism that causes material curing upon UV exposure and allows 3D printing in a layer-by-layer fashion, however, interaction of ceramic particles with the UV light produces significant light scattering. In turn, the light scattering commonly results in a less precise UV light pattern. As a result, the produced 3D article shapes are built with less precision and accuracy and may be overcured. Overcure in ceramic photoresin composition commonly may be a result of scattering of UV light that causes deeper penetration of UV light or polymerization in areas beyond those exposed to UV light. Overcure may result in a 3D printed article with poor mechanical strength, cracks, and/or delaminations. Poor mechanical strength, cracks, and/or delaminations may also result from polymerization accompanied by shrinkage, which creates internal stress. Cracks may form at ambient conditions and are particularly prominent during and after sintering process (high temperature processing).

In one aspect, the present technology provides a ceramic photoresin composition comprising an ethylenically unsaturated UV curable composition and at least about 70 wt % of a ceramic composition, based on the total composition. In any embodiment, the ceramic photoresin compositions may meet one or more of the following 3D printing specifications:
flowability: in any embodiment, the present compositions may have relatively low viscosity allowing material to flow and level;
high viscosity: in any embodiment, the present compositions may maintain particle stability and have limited or no sedimentation (silica has a specific gravity of 2.2 g/cm³; zircon has a specific gravity of 4.6-4.8 g/cm³; and photoresin compositions typically have a specific gravity of about 1.0-1.1 g/cm³);
fast cure & reduced overcure: in any embodiment, the present compositions may cure rapidly when exposed to UV light (or other electromagnetic radiation) to provide an article with good mechanical strength, greater precision, and reduced overcure; and/or
good layer-to-layer adhesion: in any embodiment, the present compositions may have limited cracks and delaminations, which can otherwise result in parts failure during post processing and metal casting.

In any embodiment, the ceramic photoresin composition may include at least about 70 wt % of the ceramic composition, based on the total composition. In any embodiment, the ceramic photoresin composition may include at least about 72 wt % of the ceramic composition, based on the total composition. In any embodiment, the ceramic photoresin composition may include at least about 75 wt % of the ceramic composition, based on the total composition. In any embodiment, the ceramic photoresin composition may include about 70 wt % to about 95 wt % of the ceramic composition including about 70 wt % to about 90 wt %, about 72 wt % to about 95 wt %, about 72 wt % to about 90 wt %, about 75 wt % to about 90 wt %, about 75 wt % to about 95 wt %, or about 75 wt % to about 85 wt %.

In any embodiment, the ceramic composition may include silica (i.e., silicon dioxide). In any embodiment, the ceramic composition may include at least about 50 wt % silica, at least about 55 wt % silica, at least about 60 wt % silica, at least about 65 wt % silica, at least about 72 wt % silica, or at least about 75 wt % silica, based on the total ceramic composition. In any embodiment, the ceramic composition may include about 50 wt % to about 100 wt % silica, about 55 wt % to about 100 wt % silica, about 60 wt % to about 100 wt % silica, about 65 wt % to about 100 wt % silica, about 70 wt % to about 100 wt % silica, or about 75 wt % to about 100 wt % silica, based on the total ceramic composition.

In any embodiment, the ceramic composition may further include zircon, alumina, zirconia, mullite, mineral materials, yittria, or a combination of two or more thereof. In any embodiment, the ceramic composition may further include zircon. In any embodiment, the ceramic composition may include silica and zircon. In any embodiment, the ceramic composition may include about 85 wt % to about 99 wt % silica and about 1 wt % to about 15 wt % zircon, about 90 wt % to about 99 wt % silica and about 1 wt % to about 10 wt % zircon, or about 95 wt % to about 99 wt % silica and about 1 wt % to about 5 wt % zircon, based on the total ceramic composition.

In any embodiment, the ceramic composition may include particles of silica, zircon, alumina, zirconia, mullite, mineral materials, and/or yittria having a particle size of less than about 100 μm. In any embodiment, the particles may have a particle size of about 0.1 μm to about 100 μm. In any embodiment, the particles may have a particle size of about 0.1 μm to about 90 μm, about 0.1 μm to about 80 μm, about 0.1 μm to about 70 μm, about 0.5 μm to about 60 μm, about 0.5 μm to about 50 μm, about 0.5 μm to about 40 μm, about 1.0 μm to about 30 μm, about 1.0 μm to about 20 μm, or about 1.0 μm to about 10 μm. In any embodiment, the particles may have a particle size of less than about 90 μm, less than about 80 μm, less than about 70 μm, less than about 60 μm, less than about 55 μm, less than about 50 μm, less than about 45 μm, less than about 40 μm, less than about 35 μm, less than about 30 μm, less than about 25 μm, less than about 20 μm, less than about 15 μm, less than about 10 μm, or less than about 5 μm. In any embodiment, the particles may be spherical particles, nonspherical particles, or a combination thereof. In any embodiment, some particles may be spherical particles and other particles maybe nonspherical particles. In any embodiment, the silica may include a first particle having a size of about 0.1 μm to about 30 μm, about 0.25 μm to about 20 μm, or about 0.5 μm to about 15 μm. In any embodiment, the silica may include a second particle having size of less than about 90 μm, less than about 70 μm, or less than about 50 μm. In any embodiment, the first particle may be spherical and the second particle may be non-spherical. In any embodiment, the ceramic composition may include about 60 wt % to about 84 wt % of the first particle, about 15 wt % to about 35 wt % of the second particle, and about 1 wt % to about 5 wt % zircon.

In any embodiment, the ethylenically unsaturated UV curable composition may include a ethylenically unsaturated UV curable monomer or oligomer that includes one or more functional groups. In any embodiment, the one or more functional groups may include a (meth)acrylate. In some embodiments, the ethylenically unsaturated UV curable monomer or oligomer may include a monofunctional monomer or oligomer such as alkyl (meth)acrylates (e.g., C₁-C₁₂ alkyl (meth)acrylates such as methyl (meth)acrylate, ethyl (meth)acrylate, propyl (meth)acrylate, butyl (meth)acrylate, pentyl (meth)acrylate, hexyl (meth)acrylate, heptyl (meth)acrylate, octyl (meth)acrylate), and/or lauryl methacrylate); acrylonitrile; styrene; itaconic acid; (meth)acrylic acid; hydroxyl functional (meth)acrylates (e.g., hydroxyethyl (meth)acrylate and hydroxybutyl (meth)acrylate); or combinations of two or more thereof. In some embodiments, the monofunctional monomer or oligomer may include hydroxyethyl acrylate and/or hydroxybutyl acrylate.

In some embodiment, the ethylenically unsaturated UV curable monomer or oligomer may include a first di- or tri-functional monomer or oligomer. The first di- or tri-functional monomer or oligomer may include a di- or tri-(meth)acrylate monomer or oligomer. In some embodiments, the first di- or tri-functional monomer or oligomer may include one or more compounds of Formula A:

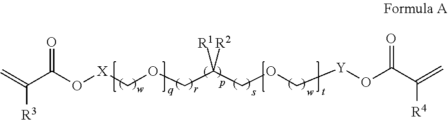

wherein:

R¹ is H or C₁-C₆ alkyl;

R² is H or

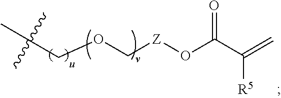

R³, R⁴, and R⁵ are independently H or CH₃;

X, Y, and Z are independently absent or a C₁-C₆ alkylene group;

p is 0 or 1;

w at each occurrence is independently 1, 2, or 3;

q is 0 or an integer from 1-100;

t is 0 or an integer from 1-100;

r, s, u, and v are independently 0, 1, 2, 3, or 4.

In some embodiments, the compound represented by Formula A is subject to the proviso that q+t is no more than 100.

In some embodiments, p may be 1, and R¹ and R² may be H. In some embodiments, q, r, s, t, and w may be 0, and X and Y may independently be C₂-C₅ alkylene. In some embodiments, R³, R⁴, and R⁵ may be H. In some embodiments, R³, R⁴, and R⁵ may be CH₃. In some embodiments, the compound of Formula A may be 1,6-hexanediol diacrylate.

In some embodiments, p may be 1, R¹ may be C₁-C₆ alkyl, and R² may be

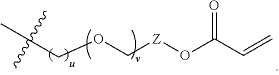

In some embodiments, X, Y, and Z may be absent; w may be 2; and q, r, s, t, u, and v may be 1. In some embodiments, X, Y, and Z may be independently C₁-C₃ alkylene; w may be 1; and q, r, s, t, u, and v may be 1. In some embodiments, R³, R⁴, and R⁵ may be H. In some embodiments, R³, R⁴, and R⁵ may be CH₃. In some embodiments, the compound of Formula A may be ethoxylated trimethylolpropan-acrylic acid ester.

In some embodiments, r, p, and s may be 0; X and Y may be absent; w may be 2; and u and v may independently be 0, 1, 2, 3, or 4. In some embodiments, q+t may be no more than 50, no more than 40, no more than 30, no more than 20, or no more than 15. In some embodiments, q may be 0 or an integer from 1-15. In some embodiments, t may be 0 or an integer from 1-15. In some embodiments, R³, R⁴, and R⁵ may be H. In some embodiments, R³, R⁴, and R⁵ may be CH₃. In some embodiments, the compound of Formula A may be polyethylene glycol diacrylate with about 10-15 glycol units.

In some embodiments, R³, R⁴, and R⁵ may be H. In some embodiments, R³, R⁴, and R⁵ may be CH₃.

In any embodiment, the first di- or tri-(meth)acrylate monomer or oligomer may include 1,6-hexanediol diacrylate, ethoxylated trimethylolpropan-acrylic acid ester, polyethylene glycol diacrylate, or a combination of two or more thereof.

In any embodiment, the ethylenically unsaturated UV curable monomer or oligomer may further include a second monomer or oligomer that includes one or more functional groups. In any embodiment, the second monomer or oligomer may include a second di- or tri-(meth)acrylate monomer or oligomer. In any embodiment, the second monomer or oligomer may have a molecular weight less than about 5000 g/mol, less than about 4000 g/mol, less than about 3000 g/mol, or less than about 2000 g/mol. In any embodiment, the second di- or tri-(meth)acrylate monomer or oligomer may include a di(meth)acrylate, wherein the (meth)acrylates are connected by a linker of 6 or more atoms comprising C, N, O, Si.

In any embodiment, the second di- or tri-(meth)acrylate monomer or oligomer may include 2-propenoic acid-1,1′-(1,6-hexanediyl)ester, 1,6-hexanediol di-2-propenoate, 4-hydroxybutyl acrylate, 3,3,5-trimethyl cyclohexyl acrylate, 4-acrylolmorpholine, 3-acryloxy-2-hydroxypropoxypropyl terminated polydimethylsiloxane, 2-propenoic acid 1,4-butanediyl-bis[oxy(2-hydroxy-3,1-propanediyl)] ester, 4-(1,1-dimethylethyl)cyclohexyl acrylate, an oligomeric urethane acrylate, or a combination of two or more thereof. In any embodiment, the oligomeric urethane acrylate may include a polymer based on urethane and acrylic ester. In any embodiment, the oligomeric urethane acrylate may include Laromer® UA 9072. In any embodiment, the oligomeric urethane acrylate may include an acrylated aliphatic urethane. In any embodiment, the oligomeric urethane acrylate may include 1,1-methylenebis4-isocyanatocyclohexane and 2-oxepanone. In any embodiment, the oligomeric urethane acrylate may include a resin based on 1,4-butanediylbis[oxy(2-hydroxy-3,1-propanediyl)] diacrylate.

In any embodiment, the first and/or second di- or tri-(meth)acrylate monomer or oligomer may have a glass transition temperature (T_{g}) of less than about 75° C. including less than about 60° C. or less than about 50° C. In any embodiment, the first and/or second di- or tri-(meth)acrylate monomer or oligomer may have a T_{g} of about −50° C. to about 75° C. In any embodiment, first and/or second di- or tri-(meth)acrylate monomer or oligomer may have a T_{g} of about −45° C. to about 20° C. In any embodiment, first and/or second di- or tri-(meth)acrylate monomer or oligomer may have a T_{g} of about 35° C. to about 50° C. In any embodiment, first and/or second di- or tri-(meth)acrylate monomer or oligomer may have a T_{g} of about 10° C. to about 30° C. In some embodiments, the ethylenically unsaturated UV curable monomer or oligomer may include two or more monomers or oligomers having a T_{g} of about 35° C. to about 50° C., about −45° C. to about 20° C., and/or about 10° C. to about 30° C.

In some embodiment, the ethylenically unsaturated UV curable monomer or oligomer may include 1,6-hexanediol diacrylate, hexane-1,6-diol diacrylate, hexamethylene glycol diacrylate, hexamethylene diacrylate, hexaneglycol diacrylate, hexane-1,6-diyl diacrylate, 1,6-bis(acryloyloxy)hexane, 2-propenoic acid 1,1′-(1,6-hexanediyl) ester, 1,6-hexanediol di-2-propenoate, ethoxylated trimethylolpropan acrylic acid ester, polyether-modified acrylate oligomer, low-viscosity trifunctional reactive monomer, polyethylene glycol diacrylate, 3-acryloxy-2-hydroxypropoxypropyl terminated polydimethylsiloxane, 2-propenoic acid 1,4-butanediylbis[oxy(2-hydroxy-3,1-propanediyl)] ester, 4-(1,1-dimethylethyl)cyclohexyl acrylate, a polymeric urethane acrylate, or a combination of two or more thereof.

In any embodiment, the composition may include about 5 wt % to about 30 wt % of the ethylenically unsaturated UV curable composition, based on the total composition. In any embodiment, the composition may include about 10 wt % to about 25 wt % or about 15 wt % to about 20 wt % of the ethylenically unsaturated UV curable composition, based on the total composition.

In any embodiment, the composition may include a photoinitiator. The photoinitiator may be any polymerization initiator capable of initiating radical polymerization of polymerizable monomers, oligomers, and prepolymers when irradiated with electromagnetic radiation. In any embodiment, the photoinitiator may include phenylglyoxylates, α-hydroxyketones, α-aminoketones, benzyldimethylketal, monoacylphosphinoxides, bisacylphosphinoxides, benzophenones, phenyl benzophenone, oxime esters, titanocene, or a combination of two or more thereof. In any embodiment, the photoinitiator may include 1-hydroxycyclohexyl phenyl ketone, ethyl (2,4,6-timethylbenzoyl)phenylphosphinate, 2,4,6-trimethylbenzoyl diphenylphosphine oxide, bis(η5-2,4-cylcopentadien-1-yl)-bis(2,6-difluoro-3-(1H-pyrrol-1-yl)-phenyl) titanium, or a combination of two or more thereof. In any embodiment, the photoinitiator may include 1-hydroxycyclohexyl phenyl ketone, ethyl (2,4,6-timethylbenzoyl)phenylphosphinate, 2,4,6-trimethylbenzoyl diphenylphosphine oxide, or a combination of two or more thereof.

In any embodiment, the composition may include about 0.01 wt % to about 10 wt % of the photoinitiator or about 0.05 wt % to about 5 wt % of the photoinitiator, based on the total composition. In any embodiment, the composition may include 0.1-9 wt %, 0.1-8 wt %, 0.1-7 wt %, 0.1-6 wt %, 0.1-5 wt %, 0.1-4 wt %, 0.1-3 wt %, 0.1-2 wt %, or 0.1-1 wt % total photoinitiator, based on the total composition. In any embodiment, the composition may include 0.08 wt % to about 3 wt % total photoinitiator, based on the total composition. In any embodiment, the composition may include 0.08 wt % to about 1.75 wt % total photoinitiator, based on the total composition. In any embodiment, the composition may include 0.2 wt % to about 2.5 wt % total photoinitiator, based on the total composition.

In any embodiment, the composition may include a formulation additive. In any embodiment, the formulation additive may include a dispersing agent, rheology modifier, or combination thereof.

In some embodiments, the formulation additive may include urea-polyol-aliphatic copolymer (e.g., bis(2-(2-(2-butoxyethoxy)ethoxy)ethyl) (((((1,3-phenylenebis(methylene))bis(azanediyl))bis(carbonyl))bis(azanediyl))bis(4-methyl-3,1-phenylene))dicarbamate), polypropoxy diethylmethylammonium chloride, alkoxylated polyethylenimine, polyethyleneimine, polyvinyl amine, benzyl pyridinium-3-carboxylate, quaternary ammonium compound, polyvinylpyrrolidone, vinylpyrrolidone/vinylimidazole copolymer, tetra-functional block copolymers based on poly(ethylene oxide) and poly(propylene oxide) with secondary alcohol terminal groups, tetra-functional triblock copolymers based on poly(ethylene oxide) and poly(propylene oxide) with primary alcohol terminal groups, polyoxyethylene-polyoxypropylene triblock copolymer with primary alcohol terminal groups, polyoxyethylene-polyoxypropylene triblock copolymer with secondary alcohol terminal groups, mixture of aliphatic dicarboxylic acids, sodium polyacrylate aqueous solution, acrylic copolymer emulsion in water, acrylic block copolymer, high molecular weight unsaturated carboxylic acid, modified hydrogenated castor oil, fatty acid modified polyester, alcohol alkoxylate, or combination of two or more thereof.

In some embodiments, the formulation additive may include at least one nitrogen atom. In some embodiments, the formulation additive may have a hydrophilic-lipophilic balance (HLB) of less than or equal to about 7. In some embodiments, the formulation additive may have a hydrophilic-lipophilic balance (HLB) of about 1 to about 7. In some embodiments, the formulation additive may have a hydrophilic-lipophilic balance (HLB) of about 1 to about 5 including about 1 to about 3 and about 3 to about 5. In some embodiments, the formulation additive may have a hydrophilic-lipophilic balance (HLB) of about 3 to about 7 including about 3 to about 5 and about 5 to about 7.

In some embodiments, the formulation additive may include: a) about 1:1 to about 1:5 weight ratio urea-polyol-aliphatic copolymer and polypropoxy diethylmethylammonium chloride, b) alkoxylated polyethylenimine, c) tetra-functional block copolymers based on poly(ethylene oxide) and poly(propylene oxide) with secondary alcohol terminal groups, d) about 0.5:1 to about 1:0.5 wt. ratio mixture of tetra-functional block copolymers based on poly(ethylene oxide) and poly(propylene oxide) with primary and secondary alcohol terminal groups, e) acrylic block copolymer, or f) a combination of two or more thereof.

In any embodiment, the composition may include about 0.2 wt % to about 3 wt % of the formulation additive, based on the total composition. In any embodiment, the composition may include about 1.5 wt % to about 2.5 wt % of the formulation additive, based on the total composition.

In any embodiment, the composition may include a UV absorbing agent. In any embodiment, the UV absorbing agent may include hydroxyphenylbenzotriazole, nenzotriazole, hydroxyphenyl-triazine, hydroxy-phenyl-s-triazine, stilbenes or derivatives thereof, and combinations of two or more thereof. In any embodiment, the UV absorbing agent may include 2,5-thiophenediylbis(5-tert-butyl-1,3-benzoxazole, 2,5-thiophenediyl-bis(5-tert-butyl-1,3-benzoxazole), β-[3-(2-H-benzotriazole-2-yl)-4-hydroxy-5-tert-butylphenyl]-propionic acid-poly(ethylene glycol) 300-ester and bis{β[3-(2-H-benzotriazole-2-yl)-4-hydroxy-5-tert-butylphenyl]-propionic acid}-poly(ethylene glycol) 300-ester, branched and/or linear 2-(2H-benzotriazol-2-yl)-6-dodecyl-4-methyl-phenol, branched and/or linear C₇-C₉ alkyl 3-[3-(2H-benzotriazol-2-yl)-5-(1,1-dimethylethyl)-4-hydroxyphenyl]propionates and tert-butyl-hydroxyphenyl propionic acid isooctyl ester, bis(2,4-dimethylphenyl)-1,3,5-triazine and 2-[4-[(2-hydroxy-3-tridecyloxypropyl)oxy]-2-hydroxyphenyl]-4,6-bis(2,4-dimethylphenyl)-1,3,5-triazine, 2-(5-chloro-2H-benzotriazole-2-yl)-6-(1,1-dimethylethyl)-4-methyl-phenol, 2-(2-hydroxyphenyl)-benzotriazole derivative), hydroxy-phenyl-s-triazine, or a combination of two or more thereof. In any embodiment, the UV absorbing agent may include 2,5-thiophenediylbis(5-tert-butyl-1,3-benzoxazole, 2,5-thiophenediyl-bis(5-tert-butyl-1,3-benzoxazole), branched and/or linear 2-(2H-benzotriazol-2-yl)-6-dodecyl-4-methyl-phenol, branched and/or linear C₇-C₉ alkyl 3-[3-(2H-benzotriazol-2-yl)-5-(1,1-dimethylethyl)-4-hydroxyphenyl]propionates and tert-butyl-hydroxyphenyl propionic acid isooctyl ester, 2-(5-chloro-2H-benzotriazole-2-yl)-6-(1,1-dimethylethyl)-4-methyl-phenol, hydroxy-phenyl-s-triazine, or a combination of two or more thereof.

In any embodiment, the composition may include greater than 0 and less than about 0.2 wt % of the UV absorbing agent, based on the total composition. In any embodiment, the composition may include about 0.001 wt % to about 0.1 wt % of the UV absorbing agent, based on the total composition. In any embodiment, the composition may include about 10-60 ppm, 20-60 ppm, 30-60 ppm, 40-60 ppm, 50-60 ppm, or 50-70 ppm, 70 ppm-0.1% of the UV absorbing agent, based on the total composition.

In any embodiment, the UV light depth of penetration during cure may be between about 0.1 mm and about 0.2 mm.

In any embodiment, the ceramic photoresin composition may have a viscosity of less than 5000 cPs. In any embodiment, the ceramic photoresin composition may have a viscosity of less than 4000 cPs, less than 3500 cPs, less than 3000 cPs, or less than 2500 cPs.

In any embodiment, the ceramic photoresin composition may include about 5 wt % to about 30 wt % of an ethylenically unsaturated UV curable composition; about 70 wt % to about 95 wt % of a ceramic composition; about 0.05 wt % to about 5 wt % of a photoinitiator; about 0.2 wt % to about 3 wt % of a formulation additive; and greater than 0 and less than about 0.2 wt % of an UV absorbing agent. In any embodiment, the composition may have a viscosity of about 3500 cP to about 5000 cP. In any embodiment, the ethylenically unsaturated UV curable composition may include 1,6-hexanediol diacrylate, ethoxylated trimethylolpropan-acrylic acid ester, polyethylene glycol diacrylate, 2-propenoic acid-1,1′-(1,6-hexanediyl)ester, 1,6-hexanediol di-2-propenoate, 4-hydroxybutyl acrylate, 3,3,5-trimethyl cyclohexyl acrylate, 4-acrylolmorpholine, 3-acryloxy-2-hydroxypropoxypropyl terminated polydimethylsiloxane, 2-propenoic acid 1,4-butanediyl-bis[oxy(2-hydroxy-3,1-propanediyl)] ester, 4-(1,1-dimethylethyl)cyclohexyl acrylate, an oligomeric urethane acrylate, or a combination of two or more thereof. In any embodiment, the ceramic composition may include silica and optionally zircon, alumina, zirconia, mullite, mineral materials, yittria, or a combination two or more thereof. In any embodiment, the silica comprises silica particles having a particle size of less than about 100 μm. In any embodiment, the ceramic composition, photoinitiator, formulation additive, and UV absorbing agent may be any of the ceramic compositions, photoinitiators, formulation additives, and/or UV absorbing agents disclosed herein at the various weight percent disclosed herein.

In another aspect, the present technology provides a ceramic photoresin composition comprising an ethylenically unsaturated UV curable composition and less than about 70 wt % of a ceramic composition, based on the total composition. In some embodiments, the composition may include about 5 wt % to about 70 wt % of the ceramic composition, based on the total composition. In some embodiments, the composition may include about 10 wt % to about 60 wt % of the ceramic composition, based on the total composition. In some embodiments, the composition may include about 20 wt % to about 50 wt % of the ceramic composition, based on the total composition. In some embodiments, the composition may include about 30 wt % to about 90 wt % of the ethylenically unsaturated UV curable composition, based on the total composition. In some embodiments, the composition may include about 40 wt % to about 90 wt % of the ethylenically unsaturated UV curable composition, based on the total composition. The ceramic photoresin composition may include any of the other components disclosed herein including a photoinitiator, formulation additive, and/or UV absorbing agent at the recited amounts.

In another aspect, the present technology provides 3D printed articles that include UV cured successive layers of any ceramic photoresin composition disclosed herein. In any embodiment, the 3D printed articles may be geometrically complex and intricate ceramic molds and cores that may be used to cast complex metal parts such as investment casting. In another embodiment, the present technology provides a method for casting metal parts using the 3D printed article. In any embodiment, the 3D printed articles may have a smooth surface (consistent with small particle size of ceramic particles), low density, high degree of porosity, mechanical strength of about 10 MPa to about 40 MPa including about 10 MPa to about 30 MPa and about 20 MPa to about 40 MPa (as measured by Modulus of Rupture), and/or ease of removal from the cast metal part after casting. In any embodiment, the green 3D printed articles (i.e., before sintering) may have a density of about 1.65 g/cm³ to about 1.99 g/cm³ (including about 1.75 g/cm³ to about 1.95 g/cm³ or about 1.82 g/cm³ to about 1.90 g/cm³. In any embodiment, the brown 3D printed articles (i.e., after sintering) may have a density of about 1.35 g/cm³ to about 1.64 g/cm³ (including about 1.40 g/cm³ to about 1.60 g/cm³ or about 1.45 g/cm³ to about 1.55 g/cm³. In any embodiment, the brown 3D printed articles may have a porosity of about 25% to about 40% (including about 27% to about 35% or about 29% to about 32%). In any embodiment, the brown 3D printed articles may have a density of about 1.45 g/cm³ to about 1.55 g/cm³, a porosity of about 29% to about 32%, or a combination thereof.

In another aspect, the present technology provides a photoresin composition that includes the ethylenically unsaturated UV curable composition. The photoresin composition may include any of the other components disclosed herein including a photoinitiator, formulation additive, and/or UV absorbing agent at the recited amounts. In some embodiments, the photoresin composition does not include the ceramic composition.

The present technology also provides a 3D printed resin that includes UV cured successive layers of the photoresin composition. Mechanical strength is another important characteristic of 3D printed materials. Since 3D printed articles are built in layer-by-layer fashion, the material must cure fast and strong to support subsequent layers. In some embodiments, the mechanical properties of ceramic photoresin compositions may be predicted by the mechanical strength of the photoresin composition (i.e., the ceramic photoresin compositions without the ceramic composition). In some embodiments, the 3D printed resins may have a maximum storage modulus after 0.15 second of 260 mW/cm² radiation (i.e. 39 mJ/cm² dosage) of about 1×10³ Pa to about 1×10⁶ Pa. In some embodiments, the 3D printed resins may have a maximum storage modulus after radiating with 39 mJ/cm² UV radiation of about 1×10⁴ Pa to about 1×10⁵ Pa. In some embodiments, the 3D printed resins may have a maximum storage modulus after 0.20 second of 260 mW/cm² radiation (52 mJ/cm² dosage) UV radiation of about 1×10² Pa to about 1×10⁶ Pa. In some embodiments, the 3D printed resins may have a maximum storage modulus after 0.20 second of radiation of about 1×10³ Pa to about 1×10⁶ Pa. In some embodiments, the 3D printed articles may have a maximum storage modulus after 0.25 second of 260 mW/cm2 (65 mJ/cm² dosage) UV radiation of about 1×10³ Pa to about 1×10⁷ Pa. In some embodiments, the 3D printed articles may have a maximum storage modulus after 0.25 second of radiation (65 mJ/cm² dosage) of about 1×10⁴ Pa to about 1×10⁷ Pa. In some embodiments, the 3D printed resins may have a maximum storage modulus of at least about 2.5×10³ Pa after cure.

In some embodiments, the photoresin composition may include a photoinitiator such as 1-hydroxycyclohexyl phenyl ketone, ethyl (2,4,6-timethylbenzoyl)phenylphosphinate, 2,4,6-trimethylbenzoyl diphenylphosphine oxide, bis(η5-2,4-cylcopentadien-1-yl)-bis(2,6-difluoro-3-(1H-pyrrol-1-yl)-phenyl) titanium, or a combination of two or more thereof. In some embodiments, the photoinitiator may include 1-hydroxycyclohexyl phenyl ketone, ethyl (2,4,6-timethylbenzoyl)phenylphosphinate, 2,4,6-trimethylbenzoyl diphenylphosphine oxide, or a combination of two or more thereof.

In another aspect, the present technology provides a method for producing the ceramic photoresin composition disclosed herein. The method includes: providing the ethylenically unsaturated UV curable composition and optionally the photoinitiator, the formulation additive, and/or the UV absorbing agent to provide a first mixture; mixing and heating the first mixture; optionally adding a photoinitiator to the first mixture; adding the ceramic composition to the first mixture to provide a second mixture; and mixing the second mixture.

In another aspect, the present technology provides a method for producing a 3D printed article. The method includes: applying successive layers of ceramic photoresin composition disclosed herein to fabricate a three-dimensional article; and irradiating the successive layers with UV irradiation. In any embodiment, the applying may include depositing a first layer of the ceramic photoresin composition to a substrate and applying a second layer of the ceramic photoresin composition to the first layer and applying successive layers thereafter. In any embodiment, the UV radiation may include a wavelength of about 300 nm to about 500 nm. In any embodiment, the UV radiation may include a wavelength of about 325 nm to about 450 nm, about 340 nm to about 425 nm, about 355 nm to about 375 nm, about 360 nm to about 370 nm, about 395 nm to about 415 nm, about 400 nm to about 410 nm. In any embodiment, the UV irradiating may be conducted for less than about 5.0 seconds, about 2.0 seconds, less than about 1.8 seconds, less than about 1.5 seconds, less than about 1.0 second, less than about 0.5 seconds, or less than about 0.25 seconds. In any embodiment, the UV irradiating may be at a power of about 10 mW/cm² to about 80 mW/cm². In any embodiment, the 3D printed article may be printed using a CeraRay, Prodways L5000, Origin MDK, Miicraft, and/or Formlabs 2.

In any embodiment, the UV irradiating may be conducted for less than about 5.0 seconds, about 2.0 seconds, less than about 1.8 seconds, less than about 1.5 seconds, or less than about 1.0 second. In any embodiment, the UV irradiating may be conducted for about 0.8 seconds to about 5 seconds. In any embodiment, the UV irradiating may be conducted for about 1.5 seconds to about 2.0 seconds or about 1.1 seconds to about 1.5 seconds. In any embodiment, the UV irradiating may be at a power of about 10 mW/cm² to about 20 mW/cm² (including about 12 mW/cm² to about 18 mW/cm² or about 14 mW/cm² to about 17 mW/cm². In any embodiment, the UV radiation may include a wavelength of about 325 nm to about 450 nm, about 340 nm to about 425 nm, about 360 nm to about 410 nm, about 370 nm to about 405 nm, about 375 nm to about 395 nm, about 380 nm to about 390 nm. In any embodiment, the UV irradiating may be at a wavelength of 385 nm. In any embodiment, the 3D printed article may be printed using an Origin MDK.

In any embodiment, the UV irradiating may be conducted for less than about 0.5 seconds, less than about 0.4 seconds, less than about 0.3 seconds, or less than about 0.25 seconds. In any embodiment, the UV irradiating may be conducted for about 0.1 seconds to about 0.5 seconds. In any embodiment, the UV irradiating may be conducted for about 0.1 seconds to about 0.3 seconds or about 0.1 seconds to about 0.2 seconds. In any embodiment, the UV irradiating may be at a power of about 40 mW/cm² to about 80 mW/cm² (including about 50 mW/cm² to about 70 mW/cm² or about 55 mW/cm² to about 65 mW/cm². In any embodiment, the UV radiation may include a wavelength of about 325 nm to about 450 nm, about 340 nm to about 415 nm, about 350 nm to about 385 nm, or about 360 nm to about 370 nm. In any embodiment, the UV irradiating may be at a wavelength of 365 nm. In any embodiment, the 3D printed article may be printed using a Prodways L5000.

The present technology, thus generally described, will be understood more readily by reference to the following examples, which are provided by way of illustration and are not intended to be limiting of the present technology.

### EXAMPLES

Example 1A. General Procedure for the Preparation of Ceramic Photoresin Compositions. To produce the resin composition, the monomers and oligomers were introduced to a mixing vessel. If present, the dispersant agent, rheology modifier, and/or UV absorbing compound were also added to the mixing vessel. The mixture was placed in the oven and heated to 30° C. to 35° C. with slow agitation. Next, a free-radical photoinitiator was added to the composition followed by the gradual addition of individual proportions of the ceramic powder (e.g., preferably 10-15% of the total ceramic powder is added per individual proportion to provide a homogenous blend). After the addition of the first portion of the ceramic powder, the mixture was allowed to mix well until the agitator torque was reduced and reached equilibrium (approximately 10 minutes or longer). Each portion of ceramic powder was added in the same step-wise manner until all of the ceramic powder was added. The formulation was then mixed for 1 to 2 hours while monitoring the torque. Once the torque dropped and stayed consistent, the composition was mixed for additional 2 to 3 hours (or longer), until homogeneous.

Example 1B. General Procedure for determining Depth of Cure of Ceramic Photoresin Compositions. Using 3D printer Prodways L5000, the thickness of cured 3D printed articles were measured (C_{d}) and the depth of cure (Dₚ) was calculated using the equation below. Dₚ values may vary based on UV irradiation wavelength, exposure time, and amount of UV absorber present in the ceramic photoresin composition. Larger Dₚ values are commonly due to a combination of deep light penetration, absorption by photoinitiator, absorption by UV absorbing additives, and/or scattering of light on ceramic particles. Unless otherwise specified, E_{c} and Dₚ values were measured for 365 nm irradiation and verified independently using 365 nm light source.

$${C}_{d} = {D}_{p} * ln ( \frac{E}{{E}_{c}} )$$

where:

C_{d} is a measured cure depth (mm)

Dₚ is the calculated depth of penetration (mm)

E is a controlled irradiation intensity (mJ/cm² or mW/cm²)

E_{c} is a calculated critical energy (mJ/cm² or mW/cm²).

Example 1C. General Procedure for determining rheology and viscosity. Unless otherwise specified, rheological measurements were performed with a TA Instrument DHR-2 rheometer using a 50-mm stainless steel parallel plate upper geometry and a Peltier plate lower geometry set to 25° C. Unless otherwise specified, viscosity was measured as a function of shear rate, where shear rate was swept from 100 l/s to 0.01 l/s over 10 minutes. Each sample was measured in duplicate following a mixing protocol developed to ensure reproducible results. Typically, less than 10 minutes occurred between each measurement, because longer time periods between measurements resulted in inconsistent measurements with a shift toward increased viscosity.

Example 2. Ceramic Photoresin Compositions Formulas A, B, and C. Following the procedure of Example 1, Formulas A, B, and C were produced. The components in Formulas A, B, and C are provided in Table 1 below. Formulas A, B, C, and D were 3D printed using a Prodways L5000 machine with laser wavelength of 365 nm and 100 micron layer thickness. The 3D printed green part could then be thermally sintered at a temperature of approximately 1150° C. to produce brown part.

TABLE 1
Exemplary Ceramic Formulas A, B, C, D

| | Formula A | | Formula B | | Formula C | | Formula D | |
|---|---|---|---|---|---|---|---|---|
| | Wt % | component | Wt % | component | Wt % | component | Wt % | component |
| Resin | V′ | 1,6-hexanediol | V″ | 1,6-hexanediol | V | 1,6-hexanediol | V | 1,6-hexanediol |
| composition | | diacrylate | | diacrylate | | diacrylate | | diacrylate |
| | | ethoxylated | | ethoxylated | | ethoxylated | | ethoxylated |
| | | trimethylolpropan | | trimethylolpropan | | trimethylolpropan | | trimethylolpropan |
| | | acrylic acid ester | | acrylic acid ester | | acrylic acid ester | | acrylic acid ester |
| | — | — | — | — | W | polyethylene glycol | W | polyethylene glycol |
| | | | | | | diacrylate | | diacrylate |
| Ceramic | X′ | Industrial grade | X | Blend of 97% silica, | X | Blend of 97% silica, | X | Blend of 97% silica, |
| powder | | ceramic⁺ | | 3% zircon⁺⁺ particles | | 3% zircon⁺⁺ particles | | 3% zircon⁺⁺ particles |
| | | | | <100 μm, spherical | | <100 μm, spherical | | <100 μm, spherical |
| | | | | and nonspherical | | and nonspherical | | and nonspherical |
| Additives | Y | polypropoxy | Y | polypropoxy | Y | polypropoxy | Y | polypropoxy |
| | | diethylmethylammonium | | diethylmethylammonium | | diethylmethylammonium | | diethylmethylammonium |
| | | chloride | | chloride | | chloride | | chloride |
| | | urea-polyol-aliphatic | | urea-polyol-aliphatic | | urea-polyol-aliphatic | | urea-polyol-aliphatic |
| | | copolymer | | copolymer | | copolymer | | copolymer |
| Photo- | Z | 1-hydroxy-cyclohexyl- | Z | 1-hydroxy-cyclohexyl- | Z | 1-hydroxy-cyclohexyl- | Z | 1-hydroxy-cyclohexyl- |
| initiator | | phenyl-ketone | | phenyl-ketone | | phenyl-ketone | | phenyl-ketone |
| UV | N/A | N/A | N/A | N/A | 0.001 | 2,5-thiophenediylbis(5- | N/A | N/A |
| absorbing | | | | | U | tert-butyl-1,3- | | |
| compound | | | | | | benzoxazole) | | |

⁺PCC Airfoils Amorphous Silica
⁺⁺The silica portion of the ceramic blend is a mixture of two silica products of different particle size distribution: (1) microspherical particles of average diameter of 1-5 μm and (2) non-spherical particles sieved to eliminate particles above 50 pm. When analyzed by light scattering analyzer (Malvern instrument), approximately 10 vol % of the particles were under 1.86 μm, approximately 50 vol % particles were under 9.08 μm, and approximately 90 vol % of the particles were under 30.9 μm; U:V′:V”:V::W:X′:X:Y:Z weight ratio is <0.002:3.6:3.2:2.2:1:15.6:16:0.4:0.4.

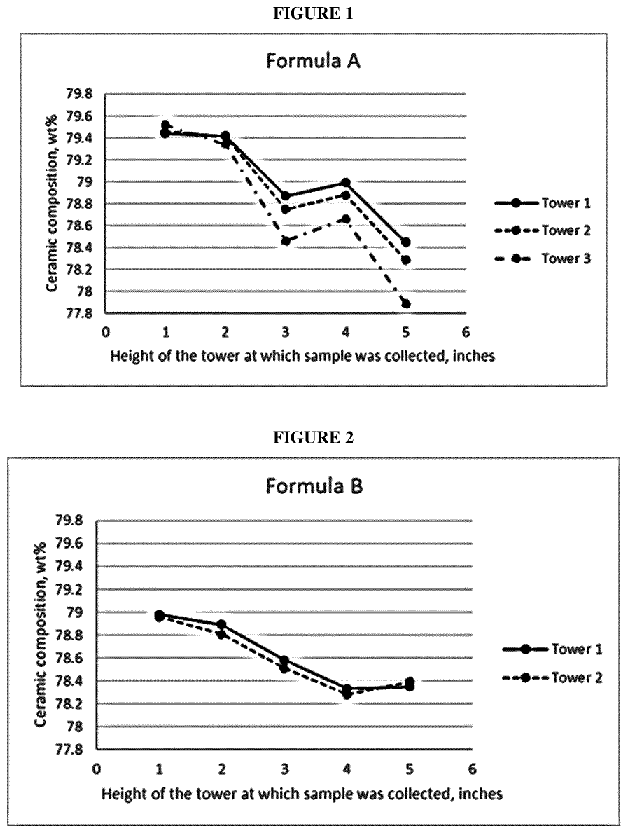

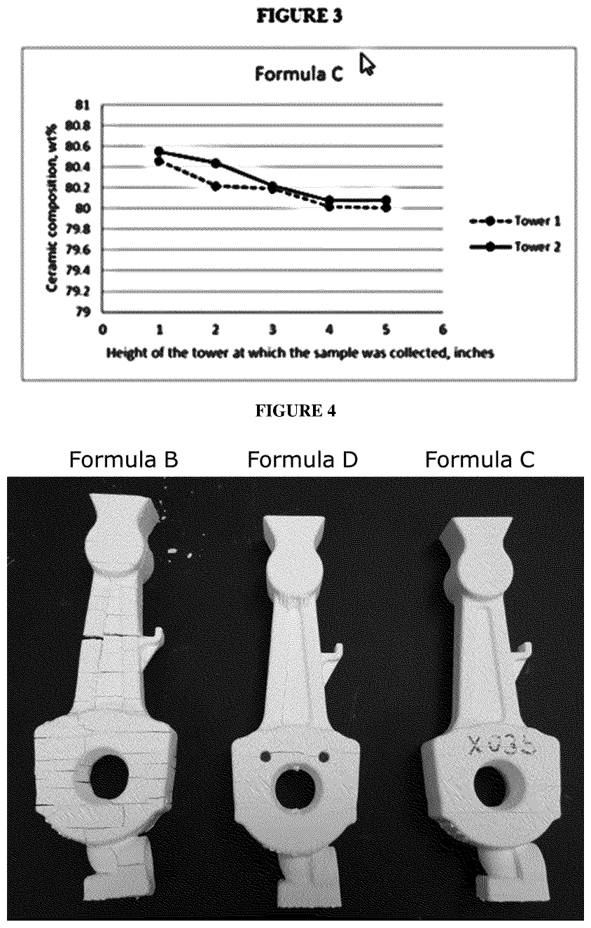

Example 3. Comparative Stability of Ceramic Photoresin Formulas A, B, and C Against Sedimentation. The stability of Formulas A, B, and C were determined based on the extent of sedimentation of ceramic particles. Sedimentation during the printing can be a problem with 3D printing compositions, since it often takes several hours to 3D print an article. To determine the sedimentation of the formulas, hollow rectangular towers were produced approximately 5 inches in height using a Prodways L5000 3D printing machine. The towers took about 10 hours to build. Once built, the 3D printed towers were sliced at 1 inch, 2 inch, 3 inch, 4 inch, and 5 inch height segments and analyzed for ceramic content in order to observe and compare compositional differences during the build time as a result of concurrent sedimentation. Each collected sample was heated up to 1000° C. to burn out organic content. The remaining ceramic content was weighed and compared to the initial weight of the sample to calculate ceramic content wt % in the sample. As shown in Table 2 below and FIGS. 1-3, Formula C exhibited substantially reduced sedimentation with minimum compositional differences throughout the 3D printed 5 inch tower as compared to Formulations A and B.

TABLE 2
Sedimentation of Ceramic Photoresin Formulas A, B, and C

| | Formula A | Formula B | Formula C |
|---|---|---|---|
| Compositional difference | 0.99-1.63% | 0.57-0.63% | <0.1% |
| measured in 3D printed 5 | | | |
| inch tall tower | | | |

Example 4. Comparative Layer-to-Layer Adhesions for Ceramic Photoresin Formulas B, C, and D. The layer-to-layer adhesion of Formulas B, C, and D were determined. Better adhesion is evidenced by reduced delamination and cracking. As illustrated in Table 3 and FIG. 4, Formula C provided a substantial reduction of cracking. Although very minor cracks are still visible in the part made with Formula C, the cracks do not cause parts failure and do not present any issues during metal casting.

TABLE 3
Cracking of Ceramic Photoresin Formulas B, C, and D

| | Formula B | Formula C | Formula D |
|---|---|---|---|
| Cracking | extensive | small | moderate |

Example 5. Comparative Reduction of UV Cure and Overcure by addition of a UV Absorbing Compound. Addition of a UV absorber can be used to control UV cure and reduce overcuring during 3D printing and/or achieve better accuracy of printed articles by controling the depth of UV light penetration and scattering. As shown in Table 1 above, 2,5-thiophenediylbis(5-tert-butyl-1,3-benzoxazole) was added to Formula C, whereas Formulas A, B, and D did not include an UV absorber. To study the effects of adding a UV absorber, Formula C was modified by increasing or decreasing the amounts of 2,5-thiophenediylbis(5-tert-butyl-1,3-benzoxazole) (Formulas 5-1 to 5-9). The formulas were printed and cured using UV irradiation at at 365 nm according to Example 1. Optimum Dₚ values for 3D printing are between 0.2 and 0.1 mm.

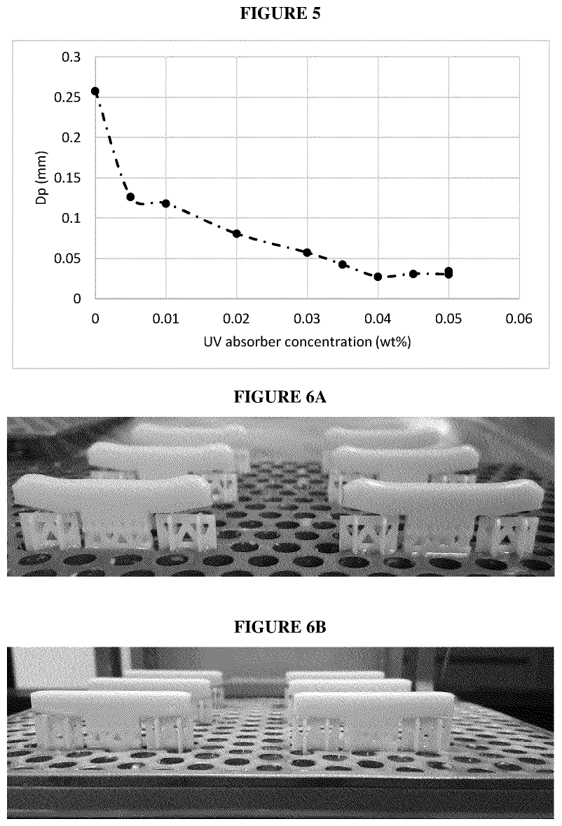

As illustrated in Table 4 and FIG. 5, the depth of cure (Dₚ) has a strong dependence on the concentration of the UV absorber in the formulation. In the absence of a UV absorber, Dₚ of 0.25 mm in Formula 5-1 caused excessive overcure and warping. Following addition of 50 ppm of 2,5-thiophenediylbis(5-tert-butyl-1,3-benzoxazole) to the composition, the overcure was substantially reduced and the Dₚ decreased to 0.1269 (Formula 5-2). At concentrations of 200 ppm and greater 2,5-thiophenediylbis(5-tert-butyl-1,3-benzoxazole), the compositions exhibited Dₚ values below 0.1 mm and produced soft materials upon UV cure due to insufficient cure (Formulas 5-4 to 5-9).

TABLE 4
Impact of Varying Amounts of UV Absorber in
Ceramic Photoresin Compositions on Cure

| | Wt % of 2,5- | | |
|---|---|---|---|
| | thiophenediylbis(5- | | |
| | tert-butyl-1,3- | Depth of | Quality of 3D |
| Formulation | benzoxazole | Cure (mm) | cured article |
| 4-1 | 0 | 0.2582 | Poor |
| 4-2 | 0.005 | 0.1269 | excellent |
| 4-3 | 0.01 | 0.1185 | fair |
| 4-4 | 0.02 | 0.0809 | Fail to print |
| 4-5 | 0.03 | 0.0574 | Fail to print |
| 4-6 | 0.035 | 0.0426 | Fail to print |
| 4-7 | 0.04 | 0.0277 | Fail to print |
| 4-8 | 0.045 | 0.0312 | Fail to print |
| 4-9 | 0.05 | 0.0308 | Fail to print |

Another benefit of adding a UV absorber and preventing overcuring is reducing stress of the 3D cured article. Stress may manifest as curling, warping, and/or distortion of the built articles. FIG. 6A shows 3D printed articles made using Formula D (does not include a UV absorber) and FIG. 6B shows similar articles built using Formula C (includes a UV absorber). Articles built using Formula C exhibited significantly less curling and warping (FIG. 6B) than those that were built with Formula D (FIG. 6A).

Example 6. Alternative UV Absorbers. Many UV absorbing compounds may be useful to improve the quality of 3D printed articles in a manner similar to 2,5-thiophenediylbis(5-tert-butyl-1,3-benzoxazole), as shown in Example 5. Other UV absorbing agents that control Dₚ and overcure were evaluated in this example. Variations of Formula C were formed by adding various UV absorbing compound (Table 5) in varying amounts ranging from 0.005 wt % to 0.02 wt % to provide Formulas 6-1 to 6-16. UV absorber A is 2,5-thiophenediylbis(5-tert-butyl-1,3-benzoxazole, 2,5-thiophenediyl-bis(5-tert-butyl-1,3-benzoxazole); UV absorber B is β-[3-(2-H-benzotriazole-2-yl)-4-hydroxy-5-tert-butylphenyl]-propionic acid-poly(ethylene glycol) 300-ester and bis{β[3-(2-H-benzotriazole-2-yl)-4-hydroxy-5-tert-butylphenyl]-propionic acid}-poly(ethylene glycol) 300-ester; UV absorber C is branched and/or linear 2-(2H-benzotriazol-2-yl)-6-dodecyl-4-methyl-phenol; UV absorber D is branched and/or linear C₇-C₉ alkyl 3-[3-(2H-benzotriazol-2-yl)-5-(1,1-dimethylethyl)-4-hydroxyphenyl]propionates and tert-butyl-hydroxyphenyl propionic acid isooctyl ester; UV absorber E is bis(2,4-dimethylphenyl)-1,3,5-triazine and 2-[4-[(2-hydroxy-3-tridecyloxypropyl)oxy]-2-hydroxyphenyl]-4,6-bis(2,4-dimethylphenyl)-1,3,5-triazine; UV absorber F is 2-(5-chloro-2H-benzotriazole-2-yl)-6-(1,1-dimethylethyl)-4-methyl-phenol; UV absorber G is 2-(2-hydroxyphenyl)-benzotriazole derivative; and UV absorber H is hydroxy-phenyl-s-triazine.

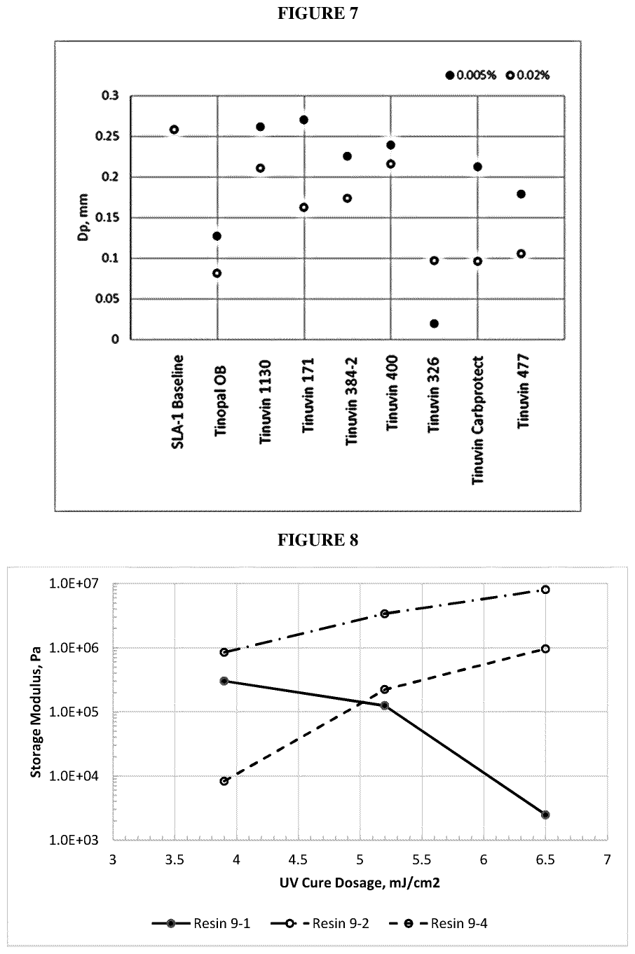

As would be evident to a person of ordinary skill in the art, other UV absorbers could also be used based on the teachings provided herein. As illustrated in Table 5 and FIG. 7, Formulas 6-2, 6-5, 6-7, 6-12, 6-15, and 6-16 provide optimum Dₚ values between 0.1 mm and 0.2 mm. Formulas 6-12 and 6-16 are preferable, since the optimum Dₚ value was achieved with the lower concentration of the UV absorber thereby demonstrating their superior effectiveness of UV absorber F and UV absorber H.

TABLE 5
Impact of Varying UV Absorbers and Amounts
in Ceramic Photoresin Compositions on Cure

| | | Wt % UV | |
|---|---|---|---|
| Formula | UV Absorber | Absorber | Dp (mm) |
| D | Control sample | 0 | 0.2582 |
| 6-1 | A | 0.02 | 0.0809 |
| 6-2 | A | 0.005 | 0.1269 |
| 6-3 | B | 0.02 | 0.2108 |
| 6-4 | B | 0.005 | 0.2613 |
| 6-5 | C | 0.02 | 0.1622 |
| 6-6 | C | 0.005 | 0.2696 |
| 6-7 | D | 0.02 | 0.173 |
| 6-8 | D | 0.005 | 0.2253 |
| 6-9 | E | 0.02 | 0.2159 |
| 6-10 | E | 0.005 | 0.2388 |
| 6-11 | F | 0.02 | 0.0967 |
| 6-12 | F | 0.005 | 0.1928 |
| 6-13 | G | 0.02 | 0.0963 |
| 6-14 | G | 0.005 | 0.2119 |
| 6-15 | H | 0.02 | 0.1052 |
| 6-16 | H | 0.005 | 0.1784 |

Example 7. Comparative Ceramic Powder Compositions in Ceramic Photoresin Compositions. To study the effects of the ceramic powder on the ceramic photoresin compositions, Formula D was modified by substituting the ceramic powder with those in Table 6 to provide Formulas 7-1 to 7-3. Although ceramic powder compositions consisting of 97% silica and 3% zircon are known in the art for investment casting, the ceramic powder compositions of the present technology include a unique blend of two silica grades with different particle size distribution. These ceramic powder compositions provide optimum rheology and sedimentation stability in 3D printed ceramic photoresin compositions.

TABLE 6
Impact of Various Ceramic Powders on the
Cured Ceramic Photoresin Composition

| | Formula 7-1 | Formula 7-2 | Formula 7-3 |
|---|---|---|---|
| Teco-Sphere Microdust | 25 | 48.5 | 72 |
| Silica Particles, Imerys (wt %) | | | |
| Teco-Sil-325 Silica | 72 | 48.5 | 25 |
| Particles, Imerys (wt %) | | | |
| Remet Zircon, fine grind | 3 | 3 | 3 |
| (wt %) | | | |
| Brookfield viscosity, spindle | 5880 | 3380 | 2710 |
| #3, 12 rpm, 25 C., 30 sec | | | |
| Sedimentation: Top clear | 1 | 2 | 1 |
| phase thickness after 24 | | | |
| hours, mm | | | |
| Sedimentation: Top clear | 4 | 5 | 4 |
| phase thickness after 2 | | | |
| weeks, mm | | | |

Teco-Sphere Microdust consists generally of amorphous silica particles ranging in about 4-6 μm in diameter. Approximately 10% of the particles are less than 1.5 μm, approximately 50% of the particles are less than 4.5 μm, and approximately 90% of the particles are less than 13.8 μm in diameter.
Teco-Sil-325 Silica Particles consists generally of non-spherical particles of larger size sieved through 325 mil mesh to eliminate particles above 50 μm diameter in size.

The results depicted in Table 6 indicate that ceramic powder particle size distribution effects viscosity and sedimentation of the ceramic photoresin composition. Mixing Teco-Sphere Microdust and Teco-Sil-325 in various proportions allows for a change in the overall particle size distribution of the ceramic blend. Formula 7-1 is a paste with a viscosity too high for 3D printing. Unlike Formula 7-1, Formulas 7-2 and 7-3 are slurries. Formula 7-3 is preferred over Formula 7-2, since it has a lower viscosity useful for 3D printing. Formulas 7-1 and 7-3 show the least sedimentation evidenced by the amount of clear liquid formed on the top of the sample after 24 hours and 14 days. It is expected to see low sedimentation in the high viscosity paste like Formula 7-1, but it is completely unexpected to see similar and very low level of sedimentation in a low viscosity slurry like Formula 7-3. Formula 7-2 with intermediate viscosity shows more pronounced sedimentation and greater amount of clear liquid formed on the top of the sample during the observed time period.

Example 8. Comparative Resin Compositions. To study the photocure and mechanical stability of the resins, various resin compositions were prepared containing the monomers in Table 7. Additionally, 2 wt % of the photoinitiator 1-hydroxy-cyclohexyl-phenyl-ketone was added to the mixtures. Each composition was radiated with 365 nm UV light of 26 mW/cm² intensity for 0.15 sec. The storage modulus before and after curing was measured for each composition using a TA Rheometer DHR-2.

Following UV irradiation, the liquid compositions photopolymerized and hardened. The maximum storage modulus measured after UV irradiation are listed in Table 7 for each resin composition. Formula 8-1 having a 2.76×10³ Pa storage modulus was used as a benchmark, since it has a known mechanical stability and utility in 3D printing. Formulas 8-2 to 8-6 contain monomers or oligomers of higher molecular weight and lower glass transition temperature; thus they allow for more flexible materials with better stress relaxation. Based on storage modulus values measured for these resin compositions, most have similar or higher mechanical stability compared to Formula 8-1. Accordingly, all resin formulas evaluated could be used for 3D printing to replace Formula 8-1 to make 3D printed articles with mechanical properties superior to those of Formula 8-1 except Formula 8-5. Though not wishing to be bound by theory, it is hypothesized that a monomer, having a longer, flexible chain reduces the degree of crosslinking and thereby provides a less rigid material and consequently a material more capable of surviving the effects of shrinking during polymerization and 3D printing.

TABLE 7
Impact of Resin Compositions on Maximum Storage

| | Formula 8-1 | | Formula 8-2 | | Formula 8-3 | | Formula 8-4 | | Formula 8-5 | | Formula 8-6 | |
|---|---|---|---|---|---|---|---|---|---|---|---|---|
| | Wt % | component | Amt. | Component | Amt. | Component | Amt. | Component | Amt. | Component | Amt. | Component |
| Resin | A′ | 1,6- | A | 1,6- | A | 1,6- | A | 1,6- | A | 1,6- | A | 1,6- |
| composition | | hexanediol | | hexanediol | | hexanediol | | hexanediol | | hexanediol | | hexanediol |
| | | diacrylate | | diacrylate | | diacrylate | | diacrylate | | diacrylate | | diacrylate |
| | B′ | ethoxylated | B | ethoxylated | B | ethoxylated | B | ethoxylated | B | ethoxylated | B | ethoxylated |
| | | trimethyl- | | trimethyl- | | trimethyl- | | trimethyl- | | trimethyl- | | trimethyl- |
| | | olpropan | | olpropan | | olpropan | | olpropan | | olpropan | | olpropan |
| | | acrylic acid | | acrylic acid | | acrylic acid | | acrylic acid | | acrylic acid | | acrylic acid |
| | | ester | | ester | | ester | | ester | | ester | | ester |
| | — | — | C | polyethylene | C | Hydroxyl | C | Aliphatic | C | Urethane | C | Urethane |
| | | | | glycol | | butyl | | epoxy | | acrylate LR | | acrylate⁺⁺ |
| | | | | diacrylate | | acrylate | | acrylate⁺ | | UA 9072 | | |
| Photo- | D | 1-hydroxy- | D | 1-hydroxy- | D | 1-hydroxy- | D | 1-hydroxy- | D | 1-hydroxy- | D | 1-hydroxy- |
| initiator | | cyclohexyl- | | cyclohexyl- | | cyclohexyl- | | cyclohexyl- | | cyclohexyl- | | cyclohexyl- |
| | | phenyl- | | phenyl- | | phenyl- | | phenyl- | | phenyl- | | phenyl- |
| | | ketone | | ketone | | ketone | | ketone | | ketone | | ketone |

| | | | | | | |
|---|---|---|---|---|---|---|
| Maximum | 2.76 × 10³ | 9.03 × 10⁴ | 2.75 × 10³ | 1.39 × 10⁵ | 1.92 × 10³ | 4.45 × 10⁴ |
| storage | | | | | | |
| modulus after | | | | | | |
| 0.15 sec | | | | | | |
| irradiation | | | | | | |
| at 260 mW/cm² | | | | | | |
| (39 mJ/cm² | | | | | | |
| dosage) (Pa) | | | | | | |

A′:B′:D weight ratio is about 8.8:1:0.2; A:B:C:D weight ratio is about 4.5:1:4.5:0.2.
⁺Oligomeric urethane acrylate with a resin based on 1,4-butanediylbis[oxy(2-hydroxy-3,1-propanediyl)] diacrylate.
⁺⁺Oligomeric acrylated aliphatic urethane containing 1,1-methylenebis4-isocyanatocyclohexane and 2-oxepanone.

Example 9. Comparative Photoinitiators and UV Curable Resins. To study the photocure and mechanical stability of resin compositions and photoinitiators, various resin compositions with a photoinitiator were made (Table 8). The formulas were cured using 365 nm UV light with intensity 26 mW/cm² using TA Rheometer DHR-2 for 0.15 sec, 0.20 sec, or 0.25 sec. Radiation dosages based on cure time are provided in Table 9. As in Example 8, Formula 8-1 having a 2.76×10³ Pa maximum storage modulus was used as a benchmark.

Similar to 1-hydroxy-cyclohexyl-phenyl-ketone, ethyl (2,4,6-trimethylbenzoyl) phenylphosphinate is known to be a good photoinitiator. However, Formula 9-3 did not show any sign of cure after being exposed to the same UV irradiation and time (365 nm UV light for 0.15 sec) as Formula 8-1. Increasing the time to 0.20 sec helped to partially cure Formula 9-3 (maximum storage modulus of 2.33×10² Pa), but it was still far below the Formula 8-1 benchmark performance of 2.76×10³ Pa. Formula 9-1 had a maximum storage modulus of 3.04×10⁵ Pa after 0.15 sec radiation, which is two orders of magnitude higher than Formula 8-1, indicating that ethyl (2,4,6-trimethylbenzoyl) phenylphosphinate photoinitiator affords an improved cure compared to 1-hydroxy-cyclohexyl-phenyl-ketone. At the same time, ethyl (2,4,6-trimethylbenzoyl) phenylphosphinate photoinitiator allowed Formula 9-4 to exhibit a maximum storage modulus of 8.34×10³ Pa after 0.15 sec irradiation, which exceeds that of Formula 8-1 at the same exposure and deemed adequate for 3D printing. Accordingly, different photoinitiators are suitable for photocuring the monomer formulas at the same wavelength (365 nm). While 1-hydroxy-cyclohexyl-phenyl-ketone works well on the majority of monomer formulas tested, using either a longer UV exposure time or different photoinitiator (e.g., ethyl (2,4,6-trimethylbenzoyl) phenylphosphinate) may be beneficial for other monomer formulas.

TABLE 8
Impact of Photoinitiator on Maximum Storage

| | Formula 9-1 | | Formula 9-2 | | Formula 9-3 | | Formula 9-4 | | Formula 9-5 | |
|---|---|---|---|---|---|---|---|---|---|---|
| | Amt | component | Amt. | Component | Amt. | Component | Amt. | Component | Amt. | Component |
| Resin | A′ | 1,6-hexanediol | E | 1,6-hexanediol | E | 1,6-hexanediol | E | 1,6-hexanediol | E | 1,6-hexanediol |
| composition | | diacrylate | | diacrylate | | diacrylate | | diacrylate | | diacrylate |
| | B′ | ethoxylated | | ethoxylated | | ethoxylated | | ethoxylated | | ethoxylated |
| | | trimethyl- | | trimethyl- | | trimethyl- | | trimethyl- | | trimethyl- |
| | | olpropan | | olpropan | | olpropan | | olpropan | | olpropan |
| | | acrylic acid | | acrylic acid | | acrylic acid | | acrylic acid | | acrylic acid |
| | | ester | | ester | | ester | | ester | | ester |
| | — | — | F | polyethylene | F | 3-acryloxy-2- | F | 3-acryloxy-2- | F | Silanol |
| | | | | glycol | | hydroxypropoxy | | hydroxypropoxy | | terminated PDMS |
| | | | | diacrylate | | propyl | | propyl | | |
| | | | | | | terminated PDMS | | terminated PDMS | | |
| Photo- | D | Ethyl (2,4,6- | G | Ethyl (2,4,6- | G | 1-hydroxy- | G | Ethyl (2,4,6- | G | Ethyl (2,4,6- |
| initiator | | trimethyl- | | trimethyl- | | cyclohexyl- | | trimethyl- | | trimethyl- |
| | | benzoyl) | | benzoyl) | | phenyl-ketone | | benzoyl) | | benzoyl) |
| | | phenyl- | | phenyl- | | | | phenyl- | | phenyl- |
| | | phosphinate | | phosphinate | | | | phosphinate | | phosphinate |

| | | | | | |
|---|---|---|---|---|---|
| Maximum | 3.04 × 10⁵ | 8.45 × 10⁵ | <10 | 8.34 × 10³ | 2.26 × 10¹ |
| storage | | | | | |
| modulus after | | | | | |
| 0.15 sec | | | | | |
| irradiation | | | | | |
| (39 mJ/cm2 | | | | | |
| dosage) (Pa) | | | | | |
| Maximum | 1.25 × 10⁵ | 3.41 × 10⁶ | 2.33 × 10² | 2.23 × 10⁵ | 3.82 × 10³ |
| storage | | | | | |
| modulus after | | | | | |
| 0.20 sec | | | | | |
| irradiation | | | | | |
| (Pa) | | | | | |
| Maximum | 2.49 × 10³ | 8.04 × 10⁶ | 2.51 × 10⁴ | 9.66 × 10⁵ | 4.25 × 10³ |
| storage | | | | | |
| modulus after | | | | | |
| 0.25 sec | | | | | |
| irradiation | | | | | |
| (Pa) | | | | | |

A′:B′:D weight ratio is 8.8:1:0.2; E:F:G weight ratio is about 1.2:1:0.05

TABLE 9
Correlation between UV exposure time and radiation dosage

| Cure time, sec | 0.15 | 0.20 | 0.25 |
|---|---|---|---|
| Dosage, mJ/cm² (Pa) | 39 | 52 | 65 |

Resin compositions 9-1, 9-2, and 9-4 indicate unique properties of selected resins can provide additional benefit for 3D printing applications. Storage modulus of cured resins as a function of UV exposure or UV dosage reported in Table 8 are plotted in FIG. 8 for resin compositions 9-1, 9-2, and 9-4. For a partially cured resin system it is typical to expect the storage modulus to increase with augmentation of dosage as an indication of unfinished curing process. This appears to be the case for resin compositions 9-2 and 9-4. However, resin composition 9-1 shows a reverse trend and the storage modulus decreases with increase of exposure time and UV dosage. During the measurement it was observed that the storage modulus for resin composition 9-1 decreases, because the resin cures faster and becomes very brittle even with a short exposure time (the lowest dosage tested here 3.9 mJ/cm²). At 0.25 and 0.50 seconds exposure times, the sample polymerized quickly and had visible cracks due to brittle nature and resulted in lower modulus values.

The high degree of cure in resin composition 9-1 was accompanied by more volumetric shrinking upon polymerization of the monomers. Such shrinking is undesirable in 3D printing application because it causes stress, volume distortions and deformation of printed parts. Thus, based on these result, resin compositions 9-2 and 9-4 provided a more advantageous product for their high mechanical strength and exceptional toughness compared to resin composition 9-1.

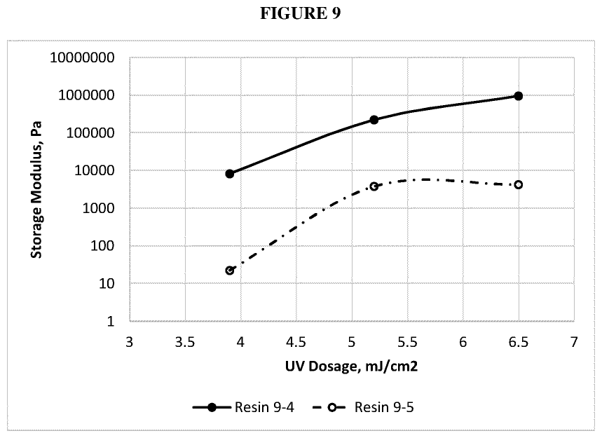

To determine if acrylate terminated polydimethylsiloxane, 3-Acryloxy-2-hydroxypropoxypropyl terminated PDMS reacts and becomes incorporated into the resin composition, resin compositions 9-4 and 9-5 were compared. Both resin compositions contained PDMS oligomers with resin composition 9-4 containing PDMS molecules with polymerizable acrylic groups and resin compositions 9-5 containing silanol terminated PDMS molecules that have no polymerizable groups. The storage modulus values increased with UV dosage for both resin compositions 9-4 and 9-5, but remained higher for 9-4 (Table 8 and FIG. 9) indicating resin composition 9-5 produced a material with lower mechanical strength. Because resin composition 9-5 included a PDMS without a polymerizable group, and because resin composition 9-5 provided a material with a lower mechanical strength compared to resin composition 9-4 (PDMS with a polymerizable group), this supports the theory that PDMS molecules with a polymerizable group do polymerize upon cure and advantageously provide a material with increased storage values and superior mechanical properties while simultaneously providing flexibility via chain flexibility and a reduced degree of crosslinking.

Example 10. Ceramic Photoresin Compositions and their Properties. To study the effects of the resin composition on the viscosity of the ceramic photoresin composition, several ceramic photoresin compositions were made with varying resin compositions (Table 10). Viscosity values were measured using a Brookfield viscometer at 25° C., spindle #3, 30 rpm and 30 sec delay. Since all of the compositions have the same ceramic powder loading, it is reasonable to assume that viscosity differences are due to the resin compositions. To be satisfactory for 3D printing, a composition should have a viscosity below 5000 cPs. All of the ceramic resin compositions with their viscosity measured in Table 10 satisfy this criteria, except Formula 10-5 with a viscosity exceeding 10,000 cPs. Likely, the high viscosity of Formula 10-5 is due to inclusion of urethane acrylate Laromer® UA 9072, which has a viscosity of about 2000-15000 cPs at 60° C. All of the other ceramic photoresin compositions in Table 10 include monomers and oligomers with a molecular weight below 4000 g/mol.

TABLE 10
Ceramic Photoresin Compositions and their Properties

| | Formula 10-1 | | Formula 10-2 | | Formula 10-3 | | Formula 10-4 | | Formula 10-5 | |
|---|---|---|---|---|---|---|---|---|---|---|
| | Amt | component | Amt | component | Amt | component | Amt | component | Amt | component |
| Resin | H' | 1,6-hexanediol | H | 1,6-hexanediol | H | 1,6-hexanediol | H | 1,6-hexanediol | H | 1,6-hexanediol |
| composition | | diacrylate | | diacrylate | | diacrylate | | diacrylate | | diacrylate |
| | | ethoxylated | | ethoxylated | | ethoxylated | | ethoxylated | | ethoxylated |
| | | trimethyl- | | trimethyl- | | trimethyl- | | trimethyl- | | trimethyl- |
| | | olpropan | | olpropan | | olpropan | | olpropan | | olpropan |
| | | acrylic acid | | acrylic acid | | acrylic acid | | acrylic acid | | acrylic acid |
| | | ester | | ester | | ester | | ester | | ester |
| | — | — | I | polyethylene | I | Hydroxyl butyl | I | Aliphatic | I | Urethane |
| | | | | glycol | | acrylate | | epoxy | | acrylate |
| | | | | diacrylate | | | | acrylate⁺ | | LR UA 9072 |
| Photo- | J | 1-hydroxy- | J | 1-hydroxy- | J | 1-hydroxy- | J | 1-hydroxy- | J | 1-hydroxy- |
| initiator | | cyclohexyl- | | cyclohexyl- | | cyclohexyl- | | cyclohexyl- | | cyclohexyl- |
| | | phenyl-ketone | | phenyl-ketone | | phenyl-ketone | | phenyl-ketone | | phenyl-ketone |
| Additives | K | polypropoxy | K | polypropoxy | K | polypropoxy | K | polypropoxy | K | polypropoxy |
| | | diethylmethyl- | | diethylmethyl- | | diethylmethyl- | | diethylmethyl- | | diethylmethyl- |
| | | ammonium | | ammonium | | ammonium | | ammonium | | ammonium |
| | | chloride | | chloride | | chloride | | chloride | | chloride |
| | L | urea-polyol- | L | urea-polyol- | L | urea-polyol- | L | urea-polyol- | L | urea-polyol- |
| | | aliphatic | | aliphatic | | aliphatic | | aliphatic | | aliphatic |
| | | copolymer | | copolymer | | copolymer | | copolymer | | copolymer |
| UV absorbing | — | — | — | — | — | — | — | — | — | — |
| additive, <0.1% | | | | | | | | | | |
| Ceramic | M | Blend of 97% | M | Blend of 97% | M | Blend of 97% | M | Blend of 97% | M | Blend of 97% |
| powder | | silica, 3% | | silica, 3% | | silica, 3% | | silica, 3% | | silica, 3% |
| | | zircon⁺⁺ | | zircon⁺⁺ | | zircon⁺⁺ | | zircon⁺⁺ | | zircon⁺⁺ |

| | | | | | |
|---|---|---|---|---|---|
| Brookfield | 1382 | 2160 | 944 | 2260 | >10000 |
| Viscosity, cPs | | | | | |
| Dp, mm | 0.24 ^{a}, 0.28 ^{b} | 0.23 ^{a}, 0.30 ^{b} | 0.25 ^{b} | 0.27 ^{b} | —^{c} |
| Ec, mJ/cm² | 5.78 ^{a}, 8.51 ^{b} | 3.80 ^{a}, 1.60 ^{b} | 6.29 ^{b} | 2.42 ^{b} | —^{c} |

| | Formula 10-6 | | Formula 10-7 | | Formula 10-8 | | Formula 10-9 | |
|---|---|---|---|---|---|---|---|---|
| | Amt | component | Amt | component | Amt | component | Amt | component |
| Resin | H | 1,6-hexanediol | H | 1,6-hexanediol | H | 1,6-hexanediol | H | 1,6-hexanediol |
| composition | | diacrylate | | diacrylate | | diacrylate | | diacrylate |
| | | ethoxylated | | ethoxylated | | ethoxylated | | ethoxylated |
| | | trimethyl- | | trimethyl- | | trimethyl- | | trimethyl- |
| | | olpropan | | olpropan | | olpropan | | olpropan |
| | | acrylic acid | | acrylic acid | | acrylic acid | | acrylic acid |
| | | ester | | ester | | ester | | ester |
| | I | Urethane | I | polyethylene | I | 3-acryloxy-2- | I | 3-acryloxy-2- |
| | | acrylate⁺⁺ | | glycol | | hydroxypropoxy | | hydroxypropoxy |
| | | | | diacrylate | | propyl | | propyl |
| | | | | | | terminated PDMS | | terminated PDMS |
| Photo- | J | 1-hydroxy- | J | 1-hydroxy- | J | 1-hydroxy- | J | Ethyl (2,4,6- |
| initiator | | cyclohexyl- | | cyclohexyl- | | cyclohexyl- | | trimethylbenzoyl) |
| | | phenyl-ketone | | phenyl-ketone | | phenyl-ketone | | phenylphosphinate |
| Additives | K | polypropoxy | K | polypropoxy | K | polypropoxy | K | polypropoxy |
| | | diethylmethyl- | | diethylmethyl- | | diethylmethyl- | | diethylmethyl- |
| | | ammonium | | ammonium | | ammonium | | ammonium |
| | | chloride | | chloride | | chloride | | chloride |
| | L | urea-polyol- | L | urea-polyol- | L | urea-polyol- | L | urea-polyol- |
| | | aliphatic | | aliphatic | | aliphatic | | aliphatic |
| | | copolymer | | copolymer | | copolymer | | copolymer |
| UV absorbing | — | — | N | 2,5- | — | — | — | — |
| additive | | | | thiophenediylbis(5- | | | | |
| | | | | tert-butyl-1,3- | | | | |
| | | | | benzoxazole) | | | | |
| Ceramic powder | M | Silica/zircon | M | Silica/zircon | M | Silica/zircon | M | Silica/zircon |
| | | blend* | | blend* | | blend* | | blend* |

| | | | | |
|---|---|---|---|---|
| Brookfield | 1456 | Not measured | 1872 | Not measured |
| Viscosity, cPs | | | | |
| Dp, mm | 0.22 ^{b} | 0.14 ^{a}, 0.12 ^{b} | 0.34 ^{b} | 0.11 ^{b} |
| Ec, mJ/cm² | 5.37 ^{b} | 6.99 ^{a}, 0.70 ^{b} | 6.27 ^{b} | 1.53 ^{b} |

^{a} Data measured on Prodways L5000 for 365 nm light source using Prodways software;
^{b} Data measured directly using a 365 nm light source and calculated as in Example 1; N/A not measured due to high material viscosity and unsuitability for 3D printing;
⁺Oligomeric urethane acrylate with a resin based on 1,4-butanediylbis[oxy(2-hydroxy-3,1-propanediyl)] diacrylate;
⁺⁺Oligomeric acrylated aliphatic urethane containing 1,1-methylenebis4-isocyanatocyclohexane and 2-oxepanone;
*same ceramic powder in Formulas B, C, and D; H′:H:I:J:K:L:M:N weight ratio is 3.2:2.2:1:0.4:0.3:0.1:16:<0.02.

Dₚ values above 0.2 mm and sometimes above 0.17 mm are considered too great to cure a 100 μm layer thick material. The ceramic photoresin compositions in Table 10 that have a Dₚ value that exceeds 0.17 mm (or at least 0.2 mm) and cannot be used “as is” for a successful printing of fine parts. Table 10 shows that two ceramic photoresin compositions have a Dₚ below 0.17 mm (Formulas 10-7 and 10-9). Both Formulas 10-7 and 10-9 are excellent candidates for SLA and DLP 3D printing. It is noteworthy that Formula 10-8 has a Dₚ value of 0.23 mm (or 0.30 mm depending on the method of evaluation), which is reduced to 0.12 mm upon addition of a UV absorbing compound (Formula 10-7). Similarly, Formula 10-8 has a Dₚ value of 0.34 mm, which is reduced to 0.11 mm by changing the photoinitiator (Formula 10-9).

Example 11. Comparative Study of Dispersing Agents in Ceramic Photoresin Compositions. As described in Example 3, it is desirable for a ceramic photoresin composition to have minimum or no sedimentation of ceramic particles for 3D printing applications, which is especially important when the printing processes spans many hours and a relatively constant composition of the printed part is required. Additives that increase formulation stability (i.e. slow sedimentation), such as dispersing agents and rheology modifiers, can be utilized to enhance ceramic photoresin composition performance. Formulas were prepared by combining 17 wt % 1,6-hexanediol diacrylate (monomer) and 2 wt % 1-hydroxy-cyclohexyl-phenyl-ketone (photoinitiator) followed by sonicating until all solids were dissolved (at least 10 minutes). Following the addition of 2 wt % of a dispersing agent (i.e. a combination of urea-polyol-aliphatic copolymer, the rheology modifier, and polypropoxy diethylmethylammonium chloride) to the sonicated mixture, the composition was mixed twice in a Flack Tek speed mixer. The 79 wt % ceramic powder was then added and the sample was mixed at least twice more in the speed mixer until combined. Viscosity as a function of shear rate was assessed using a TA Instrument DHR-2 Rheometer and corresponding viscosity values measured at low shear rate (1 l/s), which are provided in Table 11.

As shown in Table 11, the relative ratio of the two additives has a strong effect on the overall ceramic photoresin composition. The dispersant agent interacts with silica particles and helps to produce a flowable slurry (e.g., 0:1 ratio sample makes a very thin slurry with low viscosity of 1366 cP, which is prone to sedimentation). The rheology modifier helps to increase viscosity and slows sedimentation (e.g., 1:4 ratio sample has a viscosity of 4680 cP). The 1:4 ratio sample of rheology modifier:dispersant agent has been used as a benchmark throughout this example. In the absence of a dispersant agent the sample exhibits very high viscosity and appears unflowable and is a thick paste (e.g., 1:0 ratio). The presence of both a rheology modifier and a dispersant agent provides a preferred ceramic photoresin composition.

TABLE 11
Viscosity of Ceramic Photoresin Composition charged with 2 wt
% urea-polyol-aliphatic copolymer (rheology modifier) and polypropoxy
diethylmethylammonium chloride (dispersant agent).

| | | Physical | Viscosity |
|---|---|---|---|
| Additive | Ratio | appearance | (cP) |
| urea-polyol-aliphatic | 1:0 | Thick paste | * |
| copolymer: polypropoxy | 4:1 | Thick paste | * |
| diethylmethylammonium | 1:1 | Slurry | 14,724 |
| chloride | 1:4 | Slurry | 4680 |
| | 0:1 | Thin slurry | 1366 |

* too thick to measure

To study the effects of various dispersants on the ceramic photoresin compositions, 40 different dispersing agents were studied including the benchmark dispersion formula of urea-polyol-aliphatic copolymer and polypropoxy diethylmethylammonium chloride (weight ratio 1:5.4) (Table 12). The additives were used in 2 wt % concentration in the similar manner described above. Each ceramic photoresin composition was evaluated on visual flowability criteria—physical properties and physical appearance. The dispersant agents that produce flowable slurry formulations are best suited for SLA and DLP 3D printing applications. Of those studied, six were identified for forming flowable and homogenous ceramic photoresin composition slurries suitable for SLA and DLP printing applications (additives 1, 2, 15, 16, 20, and 33 in Table 12)). From the study it was determined that nitrogen-containing dispersants (or similar functionality) provide better silica particle dispersion and appropriate flowability.

Additives 2-14: All polyvinylpyrrolidone (PVP) based additives produced pastes (likely due to their high hydrophilicity). Similarly, most polyethyleneimine (PEI) based additives were not miscible in the ceramic photoresin composition or produced a paste-like compositions (likely due to their hydrophilicity). However, the alkoxylation of PEI (Additive 2) produced a homogeneous, flowable slurry (likely due to decreased hydrophilicity making it more compatible with the hydrophobic resin).

Additives 15-21: Next, amine containing tetra-functional block copolymers with either primary or secondary alcohol terminal groups were studied. The additives terminated with secondary alcohols (15, 16) performed well and produced ceramic photoresin compositions with the flowable properties of a slurry (desirable for SLA and DLP 3D printing applications). The poly(ethylene oxide) (EO) and poly(propylene oxide) (PO) can be used as “tuning knobs” to vary hydrophobicity and hydrophilicity (expressed by HLB value). Additives 15 and 16 have hydrophilic cores and hydrophobic terminal polymer blocks. The dual nature of these additives allows for interactions between the hydrophilic ceramic particles and the hydrophobic resin matrix, which results in a homogeneous suspension. Comparatively, the additives terminated with primary alcohols (17-19) performed poorly and produced paste-like ceramic photoresin compositions unsuitable for 3D printing. Likely, the poor performance can be attributed to the increased hydrophilicity of the additive's terminal polymer blocks, making them less compatible with the hydrophobic resin. Additionally, mixtures of primary and secondary alcohol terminated block copolymers were explored in 1:1 ratios (additives 20, 21). Additive 20 had superior performance (produced a slurry) to additive 21 (produced a paste), although both were 1:1 mixtures of primary and secondary alcohol terminated tetra-block copolymers. It is speculated that both the HLB and the molecular weight of the dispersing agent play a role in dispersing silica particles and controlling the rheology of the formulation. For example, sample 21 with an overall higher molecular weight than sample 20, may be the reason for sample 21's increased viscosity.

Additives 22-29: triblock PO/EO copolymers (free of amine or similar functionality) all formed pastes regardless of primary or secondary alcohol termination. Additives 30-32: are aqueous solutions all formed pastes (likely too hydrophilic). Additives 34 and 36: all contain acidic functionalities and failed to produce well dispersed slurries (likely too hydrophilic). Additive 35 formed a paste (free of amine or similar functionality and likely too hydrophilic). Additives 37-40: are alcohol alkoxylates all formed pastes (free of amine or similar functionality and likely too hydrophilic).

TABLE 12
Dispersant additives in ceramic photoresin compositions and physical properties

| | | | | | | | | | Physical |
|---|---|---|---|---|---|---|---|---|---|
| | | | | | | | | | appearance |
| | | | | | | | | | of ceramic |
| | | | Molecular | | Surface tension of | | | Other | photoresin |
| Additive | Additive | Chemical | weight | | 0.1 wt. % aq. | Viscosity | | dispersant | formulation |
| Letter | number | composition | (g/mol) | HLB | solution 25° C. | dynamic (cP) | | properties | charged with 2% |
| A | 1 | Urea-polyol-aliphatic | — | — | — | — | | | slurry |
| | | copolymer and | | | | | | | |
| | | polypropoxy | | | | | | | |
| | | diethylmethylammonium | | | | | | | |
| | | chloride, 1:5-1:4 ratio | | | | | | | |
| B | 2 | alkoxylated | — | — | — | 3000 | (b) | amine value ~25 | slurry |
| | | polyethylenimine | | | | | | (mg KOH/g) | |
| | 3 | Polyethyleneimine | 1300 | — | — | 400 | | | paste |
| | 4 | Polyethyleneimine | 2000 | — | — | 14,000 | | | not miscible |
| | 5 | Polyethyleneimine | 25,000 | — | — | >200,000 | (b) | | not miscible |
| | 6 | Polyvinyl amine | — | — | — | — | | | not miscible |
| | 7 | Polyvinyl amine | — | — | — | — | | | not miscible |
| | 8 | Benzyl | 272 | — | — | — | | 47-49% solids | not miscible |
| | | pyridinium-3- | | | | | | in water, | |
| | | carboxylate | | | | | | pH ~5.5-6.5 | |
| | 9 | Quaternary | — | — | — | 5530 | (c) | | paste |
| | | ammonium | | | | | | | |
| | | compound | | | | | | | |
| | 10 | Polyvinylpyrrolidone | K value | — | — | — | | RTV viscosity | paste |
| | | | 15-19 | | | | | 80-180 cP/30% | |
| | | | | | | | | water | |
| | 11 | Polyvinylpyrrolidone | K value | — | — | — | | RTV viscosity | paste |
| | | | 27-33 | | | | | 80-140 cP/40% | |
| | | | | | | | | water | |
| | 12 | Polyvinylpyrrolidone | K value | — | — | — | | RTV viscosity | paste |
| | | | 88-92 | | | | | 10,000-25,000 | |
| | | | | | | | | cP/20% water | |
| | 13 | Polyvinylpyrrolidone | 40,000 | — | — | — | | K value = 30, | paste |
| | | | | | | | | pH = 4 | |
| | 14 | Vinylpyrrolidone/ | 70,000 | — | — | — | | K value = 32, | paste |
| | | Vinylimidazole copolymer | | | | | | pH = 8 | |
| C | 15 | Tetra-functional block | 7240 | 7 | 42.7 | 3870 | (a) | | slurry |
| D | 16 | copolymers based on | 8000 | 1 | insoluble | 1840 | (a) | | slurry |
| | | poly(ethylene oxide) | | | | | | | |
| | | and polypropylene | | | | | | | |
| | | oxide) with secondary | | | | | | | |
| | | alcohol terminal | | | | | | | |
| | | groups | | | | | | | |
| | 17 | Tetra-functional block | 1650 | 16 | 53 | 450 | (a) | | paste |
| | 18 | copolymers based on | 3600 | 3 | 36.1 | 600 | (a) | | paste |
| | 19 | poly(ethylene oxide) | 4700 | 3 | 36.2 | 700 | (a) | | paste |
| | | and poly(propylene | | | | | | | |
| | | oxide) with primary | | | | | | | |
| | | alcohol terminal | | | | | | | |
| | | groups | | | | | | | |
| E | 20 | Mixture of tetra- | 5420* | 5* | — | — | | *average MW or | slurry |
| | | functional block | | | | | | HLB of two | |
| | | copolymers based on | | | | | | components | |
| | 21 | poly(ethylene oxide) | 5970* | 5* | — | — | | *average MW or | paste |
| | | and polypropylene | | | | | | HLB of two | |
| | | oxide) with secondary | | | | | | components | |
| | | alcohol terminal | | | | | | | |
| | | groups and primary | | | | | | | |
| | | alcohol terminal | | | | | | | |
| | | groups 1:1 ratio | | | | | | | |
| | 22 | Polyoxyethylene- | 1900 | 19 | 48.8 | 375 | (a) | | paste |
| | 23 | polyoxypropylene | 3800 | 1 | insoluble | 800 | (a) | | paste |
| | 24 | triblock copolymer | 4200 | 14 | 42 | 280 | (d) | | paste |
| | 25 | with primary alcohol | 6500 | 15 | 39.1 | 750 | (d) | | paste |
| | 26 | terminal groups | 7700 | 24 | 44 | 700 | (e) | | paste |
| | 27 | | 12600 | 22 | 40.6 | 3100 | (e) | | paste |
| | 28 | Polyoxyethylene- | 3250 | 1 | 34.1 | 660 | (a) | | paste |
| | 29 | polyoxypropylene | 3100 | 4 | 37.5 | 680 | (a) | | paste |
| | | triblock copolymer with | | | | | | | |
| | | secondary alcohol | | | | | | | |
| | | terminal groups | | | | | | | |
| | 30 | Mixture of aliphatic | — | — | — | — | | pH = 2, acid | paste |
| | | dicarboxylic acids | | | | | | value ~850 | |
| | | | | | | | | (mg KOH/g) | |
| | 31 | Polyacrylic acid, Na- | | — | — | 800 (30% as | | pH = 8 (10% dry | paste |
| | | salt aqueous solution | | | | is) (a) | | substance in | |
| | | | | | | | | dist. Water), | |
| | | | | | | | | K value ~25 | |
| | 32 | Acrylic copolymer | — | — | — | 40 | (a) | pH ~3.5 | not miscible |
| | | emulsion in water | | | | | | | |
| F | 33 | Acrylic block copolymer | — | — | — | 60,000 | (b) | | slurry |
| | 34 | High molecular weight | — | — | — | — | | acid value ~140 | paste |
| | | unsaturated carboxylic | | | | | | mg KOH/g | |
| | | acid | | | | | | | |
| | 35 | Modified hydrogenated | — | — | — | — | | | paste |
| | | castor oil | | | | | | | |
| | 36 | Fatty acid modified | — | — | — | — | | | paste |
| | | polyester | | | | | | | |
| | 37 | Alcohol alkoxylate | — | 15 | 28 | >100,000 | (a) | | paste |
| | 38 | | 640 | 14 | 31 | 150 | (a) | | paste |

| | | | | | |
|---|---|---|---|---|---|
| 39 | 500 | 14 | 27 | 300 (c), | paste |
| | | | | 60RPM | |
| 40 | 550 | 14.6 | 28 | 1200 (c), | paste |
| | | | | 60RPM | |

— unavailable information
(a) at 25° C.
(b) at 20° C.
(c) at 23° C.
(d) at 60° C.
(e) at 77° C.

Example 12A. Comparative Study of Dispersing Agents Weight Percent in Ceramic Photoresin Compositions. The six additives preferred dispersing agents identified in Example 11 were further studied to investigate the effect of additive concentrations on the ceramic photoresin compositions with respect to stability against sedimentation and suitability for 3D printing applications. Because Formula C of Example 2 had the least compositional differences when printing an article (see Example 3), Formula C was used as the base formulation to test the six additives. All ceramic photoresin compositions in this example the same as Formula C (same resin, ceramic powder, photoinitiator, UV absorbing compound) with the only variation being the dispersing agent additives and concentrations. Formulas are named using the following notation: 1^{st} letter refers to Formula C (Example 1), 2^{nd} letter refers to the dispersing agent additive (lettering scheme in Table 12) (i.e., additives 1, 2, 15, 16, 20, and 33 are referred to as A, B, C, D, E and F, respectively), and the number corresponds to the concentration of the dispersing agent (1→0.40 wt %, 2→0.79 wt %, 3→1.19 wt %, 4→1.59 wt %, 5→1.98 wt %, and 6→2.38 wt %). All formulas were prepared as described in Example 11. Changes to the dispersing agent additive wt % were balanced by a change to the total resin wt % for all formulas to maintain the constant wt % of ceramic particles across all formulas. Viscosity was measured as was done in Example 11.

All concentrations from 0.4 to 2.4 wt % of the dispersant agents studied, i.e. A, B, C, D, E and F, produced well dispersed, fluid slurries and appeared to be well suited for 3D printing (Table 13). It was determined that advantageously a single additive (additives B, C, D and F) is capable of performing two functions—dispersing agent and rheology modifier—in a manner comparable to the base formulation having two compounds (additive A) in the same amount.

TABLE 13
Preferred Dispersant Additives in Ceramic Photoresin Compositions, Physical Properties, and Sedimentation

| | | Amount (μg) of | | | | Quality of | |
|---|---|---|---|---|---|---|---|
| | Additive | additive per m² | Viscosity | Viscosity | | sedimentation | |
| Formula | Concentration | of ceramic | at 0.1/s | at 10/s | Sedimentation | rate compared | |
| name | (wt %) | surface area* | (cP) | (cP) | rate (μm/s) | to Formula C | Redispersibility |
| CA-1 | 0.40 | 9.4 ± 0.7 | 3720 | 2350 | 1.9 | Poor | Poor |
| CA-2 | 0.79 | 15.1 ± 1.1 | 3720 | 2400 | 1.65 | Poor | Poor |
| CA-3 | 1.19 | 22.8 ± 1.8 | 2750 | 2410 | 1.5 | Fair | Fair |
| CA-4 | 1.59 | 30.5 ± 2.3 | 2610 | 2350 | 1.35 | Fair | Poor |
| CA-5 | 1.98 | 38.0 ± 2.9 | 2820 | 2760 | 1.25 | — | Poor |
| CA-6 | 2.38 | 45.7 ± 3.5 | 2740 | 2690 | 1.2 | Fair | Good |
| CB-1 | 0.40 | 9.4 ± 0.7 | 3020 | 2310 | 1.5 | Fair | Good |
| CB-2 | 0.79 | 15.1 ± 1.1 | 2690 | 2200 | 1.15 | Fair | Poor |
| CB-3 | 1.19 | 22.8 ± 1.8 | 3710 | 2670 | 0.8 | Good | Fair |
| CB-4 | 1.59 | 30.5 ± 2.3 | 3800 | 2730 | 0.7 | Good | Fair |
| CB-5 | 1.98 | 38.0 ± 2.9 | 5330 | 3730 | 0.6 | Good | Fair |
| CB-6 | 2.38 | 45.7 ± 3.5 | 4650 | 3490 | 0.6 | Good | Fair |
| CC-1 | 0.40 | 9.4 ± 0.7 | 2770 | 2580 | 1.2 | Fair | Poor |
| CC-2 | 0.79 | 15.1 ± 1.1 | 2970 | 2350 | 1.2 | Fair | Fair |
| CC-3 | 1.19 | 22.8 ± 1.8 | 3380 | 2670 | 1.05 | Fair | Fair |
| CC-4 | 1.59 | 30.5 ± 2.3 | 5140 | 3620 | 0.6 | Good | Fair |
| CC-5 | 1.98 | 38.0 ± 2.9 | 4580 | 3470 | 0.75 | Good | Fair |
| CC-6 | 2.38 | 45.7 ± 3.5 | 5760 | 4240 | 0.4 | Good | Fair |
| CD-I | 0.40 | 9.4 ± 0.7 | 6150 | 3360 | 0.6 | Good | Fair |
| CD-2 | 0.79 | 15.1 ± 1.1 | 5820 | 2660 | 0.8 | Good | Good |
| CD-3 | 1.19 | 22.8 ± 1.8 | 6350 | 2950 | 0.85 | Good | Good |
| CD-4 | 1.59 | 30.5 ± 2.3 | 7560 | 4170 | 0.4 | Good | Fair |
| CD-5 | 1.98 | 38.0 ± 2.9 | 7060 | 3490 | 0.6 | Good | Good |
| CD-6 | 2.38 | 45.7 ± 3.5 | 6440 | 3910 | 0.6 | Good | Fair |
| CE-1 | 0.40 | 9.4 ± 0.7 | 3330 | 2440 | 1.3 | Fair | Good |
| CE-2 | 0.79 | 15.1 ± 1.1 | 2750 | 2450 | 1.3 | Fair | Fair |
| CE-3 | 1.19 | 22.8 ± 1.8 | 2670 | 2210 | 1.25 | Fair | Fair |
| CE-4 | 1.59 | 30.5 ± 2.3 | 3640 | 3030 | 1.05 | Fair | Fair |
| CE-5 | 1.98 | 38.0 ± 2.9 | 3070 | 2580 | 1.1 | Fair | Fair |
| CE-6 | 2.38 | 45.7 ± 3.5 | 3450 | 2910 | 0.95 | Fair | Fair |
| CF-1 | 0.40 | 9.4 ± 0.7 | 399,300 | 12,260 | ** | — | Good |
| CF-2 | 0.79 | 15.1 ± 1.1 | 2770 | 2550 | 1 | Fair | Fair |
| CF-3 | 1.19 | 22.8 ± 1.8 | 3670 | 2770 | 0.9 | Good | Fair |
| CF-4 | 1.59 | 30.5 ± 2.3 | 3970 | 3330 | 0.7 | Good | Fair |
| CF-5 | 1.98 | 38.0 ± 2.9 | 5180 | 3850 | 0.6 | Good | Fair |
| CF-6 | 2.38 | 45.7 ± 3.5 | 6380 | 4760 | 0.4 | Good | Fair |

*Values calculated using surface area range of 700-600 m²/g obtained from Malvern Instrument particle size distribution measurements and a silica density of 2.2 g/cm³
** formulation was too thick to flow into narrow cuvette for measurement

Example 12B. Dispersing Agents Effects on Shelf Life and Printing Speed in Ceramic Photoresin Compositions. The 36 formulas in Table 13 were evaluated for printability (i.e. lower viscosity allows faster printing) and resin stability (often correlated with higher viscosity). The shear thinning behavior of the ceramic photoresin compositions can be used to gauge the potential printing vs. stability performance of a formulation. To determine the shear thinning behavior, rheological measurements for each formulation were collected. Based on the rheological data, the viscosity at the low shear rate of 0.1 l/s was analyzed as an indication of shelf stability and the viscosity at a medium shear rate of 10 l/s was analyzed as an indication of 3D printability. At low shear rate, where little agitation and shear is applied to the formulation, higher viscosity values will effectively prevent sedimentation and ensure sample stability. Comparably, lower viscosity at medium shear rate will allow for ease of material handleability and faster 3D printing as well as compatibility with wide variety of 3D printers on the market. As discussed above, ceramic photoresin compositions with viscosities below 5000 cP (measured by Brookfield viscometer at 30 RPM, spindle 3, 30 sec) are acceptable for the application and yield successful 3D prints. However, for faster print speeds, it is preferred that materials viscosities are below 3500 cP.

Using 3500 cP as a preferred viscosity and mid-range shear rates of approximately 1-10 l/s (printability), the following formulas were identified as above the viscosity limit: CB-5, CC-4, CC-6, CD-4, CD-6 and CF-1, CF-5 and CF-6 (Table 13). Formulas CB-6, CC-5, and CD-5 were on the edge of the limit and could still be deemed acceptable (Table 13).

Using low shear rate as an approximation of shelf storage conditions, formulas with the highest viscosities at 0.1 l/s shear rate would be considered the most stable against sedimentation. However, the reality of 3D printing application demands some degree of flowability even at very low shear rates. Therefore, the same criterion of 5000 cP was used as a cut off viscosity to disqualify formulations with high viscosity at low shear rate. At the same time, formulations with viscosity values below 3500 cP at 0.1 l/s are considered too thin and prone to sedimentation. From the analysis of viscosities at low shear rate 0.1 l/s, formulations can be identified with low shear viscosities in the range of 3500-5000 cP as the best ceramic photoresins for 3D printing that resist sedimentation. Such formulations include:

CA-1, CA-2—lower amounts (<1 wt %) of two-component system urea-polyol-aliphatic copolymer and polypropoxy diethylmethylammonium chloride, 1:5-1:4 ratio;
CB-3, CB-4, CB-6,—1-2.4 wt % of alkoxylated polyethylenimine;
CC-5—about 2 wt % of tetra-functional block copolymer based on poly(ethylene oxide) and poly(propylene oxide) with secondary alcohol terminal groups of 7240 molecular weight and HLB 7;
CE-4—about 1.5 wt % of mixture of tetra-functional block copolymers based on poly(ethylene oxide) and poly(propylene oxide) with secondary alcohol terminal groups and primary alcohol terminal groups 1:1 ratio;
CF-3 and CF-4,—about 1-1.5 wt % of fatty acid modified polyester;
all formulas containing additive D (tetra-functional block copolymer based on poly(ethylene oxide) and poly(propylene oxide) with secondary alcohol terminal groups of 8000 molecular weight and low HLB of 1) have much higher viscosity than the threshold 5000 cPs;
CC-6, CF-1, and CF-6 are well above the optimal viscosity likely due to very low or very high concentration of additive;
CB-5, CC-4, and CF-5 are on the upper edge of the viscosity range;
Formulas CC-3, CE-1, and CE-6 are on the lower edge of the viscosity range and could still be reasonably useful in 3D printing application.

Based on the rheology of formulations used to compare dispersing agents, Formulas CA-1, CA-2, CB-3, CB-4, CB-6, CC-3, CC-5, CE-1, CE-4, CE-6, CF-3, and CF-4 are most preferred.

Example 12C. Dispersing Agents Effects on Sedimentation in Ceramic Photoresin Compositions. Sedimentation measurements were performed using a tabletop centrifuge LUMiSizer® 6502-140 (equipped with 12 channels). The LUMiSizer® measures light transmittance (865 nm) through a sample cuvette, across the length of the cuvette window as the samples are centrifuged over a defined period of time. This measurement technique provides transmittance data with both temporal and spatial information, enabling the calculation of sedimentation rate. For all measurements, measurement parameters were as follows: 25° C., 2500 RPM, 1000 scans, 7 seconds between scans. The sedimentation rate data is provided in Table 13 along with a relative quality assessment for each value as compared to Formula CA-5 (contains 2 wt. % surfactant), which is analogous to Formula C. High sedimentation rate values correspond to fast sedimentation, whereas lower sedimentation rate values indicate slower sedimentation process.

While many of the sedimentation rates compare favorably or equally to that of Formula CA-5 (the benchmark), Formulas CA-1, and CA-2 are not preferred, because their sedimentation rates are high and therefore the compositions have poor stability performance. With the combined consideration of viscosity and sedimentation rate, Formulas CB-3, CB-4, and CF-4 have the highest overall performance and Formulas CB-1, CB-6, CC-5, CC-3, CE-1, CE-4, CE-5, CE-6, and CF-3 have good performance and could also be useful for 3D printing (i.e., meet viscosity and stability criteria).

Example 12D. Dispersing Agents Effects on Long-Term Sedimentation in Ceramic Photoresin Compositions. Redispersibility of the ceramic photoresin compositions in Table 13 were studied, because long-term formulation stability and the ability to redisperse ceramic particles after extended lengths of time spent in transport or in storage is important for the successful commercialization of a ceramic photoresin compositions for 3D printing. For each formula, accelerated shelf-life was determined by mixing samples using two cycles in a Flack Tek speed mixer and subsequently placing the sample in a 40° C. oven for one week. After removal from the oven, each sample was visually inspected for the amount of (height) clear phase separation and probed with a metal spatula to qualitatively determine the amount of solid content on the container bottom. Samples were then cycled through one mixing step in the Flack Tek and one visual inspection of the sample to determine fluidity and identify solid clumps. The mixing sequence was repeated until solids in the sample were completely redispersed. The number of mixing cycles and initial sample inspection were used to classify the redispersibility of each formula as either poor, fair, or good (Table 13). While all formulations could be redispersed, some required ≥5 mixing cycles before all ceramic solids could be homogenized. In particular, Formulas CA-1, CA-2, CA-4, CA-5, CB-2, and CC-1 showed the worst redispersibility performance (“poor”). Formulations that performed well (“good”), required two or fewer mixing cycles.

While many formulations have some useful properties, the example illustrates that Formulas CB-1, CB-3, CB-4, CC-2, CC-3, CC-5, CE-1, CE-4, CE-5, CE-6, CF-3, and CF-4 are preferred, because they have the overall highest performance in viscosities at low and moderate shear rates, sedimentation rate, and redispersibility after accelerated shelf-life testing). Formulas CB-3, CB-4, CB-6, CC-5, CF-3, and CF-4 are the most preferred.

### Illustrative Embodiments

Para 1. A ceramic photoresin composition comprising an ethylenically unsaturated UV curable composition and at least about 70 wt % of a ceramic composition, based on the total composition.

Para 2. The composition of Para 1, wherein the composition comprises at least about 72 wt % of the ceramic composition, based on the total composition.

Para 3. The composition of Para 1 or Para 2, wherein the composition comprises at least about 75 wt % of the ceramic composition, based on the total composition.

Para 4. The composition of Para 1, wherein the composition comprises about 70 wt % to about 95 wt % of the ceramic composition, based on the total composition.

Para 5. The composition of any one of Paras 1, 2, or 4, wherein the composition comprises about 72 wt % to about 90 wt % of the ceramic composition, based on the total composition.

Para 6. The composition of any one of Paras 1-5, wherein the composition comprises about 75 wt % to about 85 wt % of the ceramic composition, based on the total composition.

Para 7. The composition of any one of Paras 1-6, wherein the ceramic composition comprises silica and optionally zircon, alumina, zirconia, mullite, mineral materials, yittria, or a combination two or more thereof.

Para 8. The composition of any one of Paras 1-7, wherein the ceramic composition comprises at least about 50 wt % silica, based on the total ceramic composition.

Para 9. The composition of any one of Paras 1-8, wherein the ceramic composition comprises at least about 75 wt % silica, based on the total ceramic composition.

Para 10. The composition of any one of Paras 1-9, wherein the ceramic composition comprises about 75 wt % to about 100 wt % silica, based on the total ceramic composition.

Para 11. The composition of any one of Paras 1-10, wherein the ceramic composition comprises about 85 wt % to about 99 wt % silica and about 1 wt % to about 15 wt % zircon, based on the total ceramic composition.

Para 12. The composition of any one of Paras 7-11, wherein the silica comprises silica particles having a particle size of less than about 100 μm.

Para 13. The composition of any one of Paras 7-12, wherein the silica comprises silica particles having a particle size of about 0.1 μm to about 100 μm.

Para 14. The composition of Para 12 or Para 13, wherein the silica particles comprise a first particle having a size of about 0.5 μm to about 15 μm and a second particle having size of less than about 50 μm.

Para 15. The composition of Para 14, wherein the first particle is spherical and the second particle is non-spherical.

Para 16. The composition of Para 14 or Para 15, wherein the ceramic composition comprises about 60 wt % to about 84 wt % of the first particle, about 15 wt % to about 35 wt % of the second particle, and about 1 wt % to about 5 wt % zircon.

Para 17. The composition of any one of Paras 1-16, wherein the ethylenically unsaturated UV curable composition comprises a ethylenically unsaturated UV curable monomer or oligomer comprising one or more functional groups.

Para 18. The composition of Para 17, wherein the ethylenically unsaturated UV curable monomer or oligomer comprises a first di- or tri-functional monomer or oligomer.

Para 19. The composition of Para 18, wherein the first di- or tri-functional monomer or oligomer comprise a di- or tri-(meth)acrylate monomer or oligomer.

Para 20. The composition of any one of Paras 17-19, wherein the first di- or tri-functional monomer or oligomer comprises one or more compounds of Formula A:

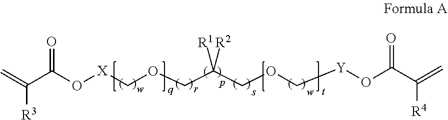

wherein:

R¹ is H or C₁-C₆ alkyl;

R² is H or

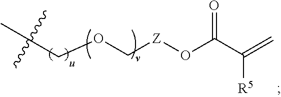

R³, R⁴, and R⁵ are independently H or CH₃;

X, Y, and Z are independently absent or C₁-C₆ alkylene group;

p is 0 or 1;

w at each occurrence is independently 1, 2, or 3;

q is 0 or an integer from 1-100;

t is 0 or an integer from 1-100;

r, s, u, and v are independently 0, 1, 2, 3, or 4;

with the proviso that q+t is no more than 100.

Para 21. The composition of Para 20, wherein p is 1, and R¹ and R² are H.

Para 22. The composition of Para 20 or Para 21, wherein q, r, s, t, and w are 0, and X and Y are independently C₂-C₅ alkylene.

Para 23. The composition of Para 20, wherein p is 1, R¹ is C₁-C₆ alkyl, and R² is

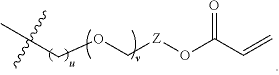

Para 24. The composition of Para 23, wherein X, Y, and Z are absent; w is 2; and q, r, s, t, u, and v are 1.

Para 25. The composition of Para 23, wherein X, Y, and Z are independently C₁-C₃ alkylene; w is 1; and q, r, s, t, u, and v are 1.

Para 26. The composition of Para 20, wherein r, p, and s are 0; X and Y are absent; w is 2; q is 0 or an integer from 1-15; t is 0 or an integer from 1-15; u and v are independently 0, 1, 2, 3, or 4; with the proviso that q+t is no more than 20.

Para 27. The composition of any one of Paras 20-26, wherein R³, R⁴, and R⁵ are H.

Para 28. The composition of any one of Paras 19-27, wherein the ethylenically unsaturated UV curable monomer or oligomer further comprises a second monomer or oligomer comprising one or more functional groups.

Para 29. The composition of Para 28, wherein the second monomer or oligomer comprises a second di- or tri-(meth)acrylate monomer or oligomer having a molecular weight less than about 4000 g/mol.

Para 30. The composition of Para 29, wherein the second di- or tri-(meth)acrylate monomer or oligomer comprises a di(meth)acrylate, wherein the (meth)acrylates are connected by a linker of 6 or more atoms comprising C, N, O, Si.

Para 31. The composition of Para 29 or Para 30, wherein the second di- or tri-(meth)acrylate monomer or oligomer has a molecular weight less than about 2000 g/mol.

Para 32. The composition of any one of Paras 17-31, wherein the first di- or tri-(meth)acrylate monomer or oligomer comprises 1,6-hexanediol diacrylate, ethoxylated trimethylolpropan-acrylic acid ester, polyethylene glycol diacrylate, or a combination of two or more thereof.

Para 33. The composition of any one of Paras 29-32, wherein the second di- or tri-(meth)acrylate monomer or oligomer comprises 2-propenoic acid-1,1′-(1,6-hexanediyl)ester, 1,6-hexanediol di-2-propenoate, 4-hydroxybutyl acrylate, 3,3,5-trimethyl cyclohexyl acrylate, 4-acrylolmorpholine, 3-acryloxy-2-hydroxypropoxypropyl terminated polydimethylsiloxane, 2-propenoic acid 1,4-butanediyl-bis[oxy(2-hydroxy-3,1-propanediyl)] ester, 4-(1,1-dimethylethyl)cyclohexyl acrylate, an oligomeric urethane acrylate, or a combination of two or more thereof.

Para 34. The composition of any one of Paras 1-33, wherein the composition comprises about 5 wt % to about 30 wt % of the ethylenically unsaturated UV curable composition, based on the total composition.

Para 35. The composition of any one of Paras 1-34, wherein the composition further comprises a photoinitiator.

Para 36. The composition of Para 35, wherein the photoinitiator comprises phenylglyoxylates, α-hydroxyketones, α-aminoketones, benzildimethylketal, monoacylphosphinoxides, bisacylphosphinoxides, benzophenones, phenyl benzophenone, oxime esters, titanocene, or a combination of two or more thereof.

Para 37. The composition of Para 35 or Para 36, wherein the photoinitiator comprises 1-hydroxycyclohexyl phenyl ketone, ethyl (2,4,6-timethylbenzoyl)phenylphosphinate, 2,4,6-trimethylbenzoyl diphenylphosphine oxide, or a combination of two or more thereof.

Para 38. The composition of any one of Paras 35-37, wherein the composition comprises about 0.05 wt % to about 5 wt % of the photoinitiator, based on the total composition.

Para 39. The composition of any one of Paras 1-38, wherein the composition further comprises a formulation additive.

Para 40. The composition of Para 39, wherein the formulation additive comprises a dispersing agent, rheology modifier, or combination thereof.

Para 41. The composition of Para 39 or Para 40, wherein the formulation additive comprises urea-polyol-aliphatic copolymer, polypropoxy diethylmethylammonium chloride, alkoxylated polyethylenimine, polyethyleneimine, polyvinyl amine, benzyl pyridinium-3-carboxylate, quaternary ammonium compound, polyvinylpyrrolidone, vinylpyrrolidone/vinylimidazole copolymer, tetra-functional block copolymers based on poly(ethylene oxide) and poly(propylene oxide) with secondary alcohol terminal groups, tetra-functional triblock copolymers based on poly(ethylene oxide) and poly(propylene oxide) with primary alcohol terminal groups, polyoxyethylene-polyoxypropylene triblock copolymer with primary alcohol terminal groups, polyoxyethylene-polyoxypropylene triblock copolymer with secondary alcohol terminal groups, mixture of aliphatic dicarboxylic acids, sodium polyacrylate aqueous solution, acrylic copolymer emulsion in water, acrylic block copolymer, high molecular weight unsaturated carboxylic acid, modified hydrogenated castor oil, fatty acid modified polyester, alcohol alkoxylate, or combination of two or more thereof.

Para 42. The composition of Para 39 or Para 40, wherein the formulation additive comprises at least one nitrogen atom.

Para 43. The composition of any one of Paras 39-42, wherein the formulation additive has a hydrophilic-lipophilic balance (HLB) of less than or equal to about 7.

Para 44. The composition of Para 39 or Para 40, wherein the formulation additive comprises:
a) about 1:1 to about 1:5 weight ratio urea-polyol-aliphatic copolymer and polypropoxy diethylmethylammonium chloride,
b) alkoxylated polyethylenimine,
c) tetra-functional block copolymers based on poly(ethylene oxide) and poly(propylene oxide) with secondary alcohol terminal groups,
d) about 0.5:1 to about 1:0.5 wt. ratio mixture of tetra-functional block copolymers based on poly(ethylene oxide) and poly(propylene oxide) with primary and secondary alcohol terminal groups,
e) acrylic block copolymer, or
f) a combination of two or more thereof.

Para 45. The composition of any one of Paras 39-44, wherein the composition comprises about 0.2 wt % to about 3 wt % of the formulation additive, based on the total composition.

Para 46. The composition of any one of Paras 1-45, wherein the composition further comprises a UV absorbing agent.

Para 47. The composition of Para 46, wherein the UV absorbing agent comprises hydroxyphenylbenzotriazole, nenzotriazole, hydroxyphenyl-triazine, hydroxy-phenyl-s-triazine, stilbenes or derivatives thereof, and combinations of two or more thereof.

Para 48. The composition of Para 46 or Para 47, wherein the UV absorbing agent comprises 2,5-thiophenediylbis(5-tert-butyl-1,3-benzoxazole, 2,5-thiophenediyl-bis(5-tert-butyl-1,3-benzoxazole), β-[3-(2-H-benzotriazole-2-yl)-4-hydroxy-5-tert-butylphenyl]-propionic acid-poly(ethylene glycol) 300-ester and bis{β[3-(2-H-benzotriazole-2-yl)-4-hydroxy-5-tert-butylphenyl]-propionic acid}-poly(ethylene glycol) 300-ester, branched and/or linear 2-(2H-benzotriazol-2-yl)-6-dodecyl-4-methyl-phenol, branched and/or linear C₇-C₉ alkyl 3-[3-(2H-benzotriazol-2-yl)-5-(1,1-dimethylethyl)-4-hydroxyphenyl]propionates and tert-butyl-hydroxyphenyl propionic acid isooctyl ester, bis(2,4-dimethylphenyl)-1,3,5-triazine and 2-[4-[(2-hydroxy-3-tridecyloxypropyl)oxy]-2-hydroxyphenyl]-4,6-bis(2,4-dimethylphenyl)-1,3,5-triazine, 2-(5-chloro-2H-benzotriazole-2-yl)-6-(1,1-dimethylethyl)-4-methyl-phenol, 2-(2-hydroxyphenyl)-benzotriazole derivative), hydroxy-phenyl-s-triazine, or a combination of two or more thereof.

Para 49. The composition of any one of Paras 46-48, wherein the UV absorbing agent comprises 2,5-thiophenediylbis(5-tert-butyl-1,3-benzoxazole, 2,5-thiophenediyl-bis(5-tert-butyl-1,3-benzoxazole), branched and/or linear 2-(2H-benzotriazol-2-yl)-6-dodecyl-4-methyl-phenol, branched and/or linear C₇-C₉ alkyl 3-[3-(2H-benzotriazol-2-yl)-5-(1,1-dimethylethyl)-4-hydroxyphenyl]propionates and tert-butyl-hydroxyphenyl propionic acid isooctyl ester, 2-(5-chloro-2H-benzotriazole-2-yl)-6-(1,1-dimethylethyl)-4-methyl-phenol, hydroxy-phenyl-s-triazine, or a combination of two or more thereof.

Para 50. The composition of any one of Paras 46-49, wherein the composition comprises greater than 0 and less than about 0.2 wt % of the UV absorbing agent, based on the total composition.

Para 51. The composition of any one of Paras 46-50, wherein the composition comprises about 0.001 wt % to about 0.1 wt % of the UV absorbing agent, based on the total composition.

Para 52. The composition of any one of Paras 46-51, wherein the UV light depth of penetration during cure between about 0.1 mm and about 0.2 mm.

Para 53. The composition of any one of Paras 1-52, wherein the composition has a viscosity of about 3500 cP to about 5000 cP.

Para 54. The composition of any one of Paras 1-53, wherein the composition is a 3D printing composition.

Para 55. A 3D printed article comprising the UV cured successive layers of the composition of any one of Paras 1-54.

Para 56. A method for casting metal parts using the 3D printed article of Para 55.

Para 57. A method for producing the composition of any one of Paras 1-54 comprising:
providing the ethylenically unsaturated UV curable composition and optionally the photoinitiator, the formulation additive, and/or the UV absorbing agent to provide a first mixture;
mixing and heating the first mixture;
optionally adding a photoinitiator to the first mixture;
adding the ceramic composition to the first mixture to provide a second mixture; mixing the second mixture.

Para 58. A method for producing a three-dimensional printed article comprising applying successive layers of one or more of the UV curable compositions of any one of Paras 1-54 to fabricate a three-dimensional article; and irradiating the successive layers with UV irradiation.

Para 59. The method of Para 58, wherein the applying comprises depositing a first layer of the composition to a substrate and applying a second layer of the composition to the first layer and applying successive layers thereafter.

Para 60. The method of Para 58 or Para 59, wherein the UV irradiation comprises a wavelength of about 300 nm to about 500 nm.

Para 61. The method of any one of Paras 58-60, wherein the irradiating is conducted for less than about 5 seconds at a power of about 10 mW/cm² to about 20 mW/cm².

Para 62. The method of any one of Paras 58-60, wherein the irradiating is conducted for less than about 0.5 seconds at a power of about 40 mW/cm² to about 80 mW/cm².

Para 63. A ceramic photoresin composition comprising:

about 5 wt % to about 30 wt % of an ethylenically unsaturated UV curable composition;
about 70 wt % to about 95 wt % of a ceramic composition;
about 0.05 wt % to about 5 wt % of a photoinitiator;
about 0.2 wt % to about 3 wt % of a formulation additive; and
greater than 0 and less than about 0.2 wt % of an UV absorbing agent;
wherein:
the composition has a viscosity of about 3500 cP to about 5000 cP;
the ethylenically unsaturated UV curable composition comprises 1,6-hexanediol diacrylate, ethoxylated trimethylolpropan-acrylic acid ester, polyethylene glycol diacrylate, 2-propenoic acid-1,1′-(1,6-hexanediyl)ester, 1,6-hexanediol di-2-propenoate, 4-hydroxybutyl acrylate, 3,3,5-trimethyl cyclohexyl acrylate, 4-acrylolmorpholine, 3-acryloxy-2-hydroxypropoxypropyl terminated polydimethylsiloxane, 2-propenoic acid 1,4-butanediyl-bis[oxy(2-hydroxy-3,1-propanediyl)] ester, 4-(1,1-dimethylethyl)cyclohexyl acrylate, an oligomeric urethane acrylate, or a combination of two or more thereof; and
ceramic composition comprises silica and optionally zircon, alumina, zirconia, mullite, mineral materials, yittria, or a combination two or more thereof; and the silica comprises silica particles having a particle size of less than about 100 μm.

Para 64. The composition of Para 63, wherein the composition is a 3D printing composition.

Para 65. A 3D printed article comprising the UV cured successive layers of the composition of Para 63 or Para 64.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1.-36. (canceled)

37. A ceramic photoresin composition comprising an ethylenically unsaturated UV curable composition and at least about 70 wt % of a ceramic composition, based on the total composition.

38. The composition of claim 37, wherein the composition comprises at least about 75 wt % to about 95 wt % of the ceramic composition, based on the total composition.

39. The composition of claim 37, wherein the ceramic composition comprises silica and optionally zircon, alumina, zirconia, mullite, mineral materials, yittria, or a combination two or more thereof.

40. The composition of claim 37, wherein the ceramic composition comprises at least about 50 wt % silica, based on the total ceramic composition.

41. The composition of claim 37, wherein the ceramic composition comprises about 85 wt % to about 99 wt % silica and about 1 wt % to about 15 wt % zircon, based on the total ceramic composition.

42. The composition of claim 40, wherein the silica comprises silica particles having a particle size of less than about 50 μm.

43. The composition of claim 42, wherein the silica particles comprise a first particle having a size of about 0.5 μm to about 15 μm and a second particle having size of less than about 50 μm.

44. The composition of claim 43, wherein the ceramic composition comprises about 60 wt % to about 84 wt % of the first particle, about 15 wt % to about 35 wt % of the second particle, and about 1 wt % to about 5 wt % zircon.

45. The composition of claim 37, wherein the ethylenically unsaturated UV curable monomer or oligomer comprises a first di- or tri-functional monomer or oligomer.

46. The composition of claim 45, wherein the first di- or tri-functional monomer or oligomer comprises one or more compounds of Formula A: 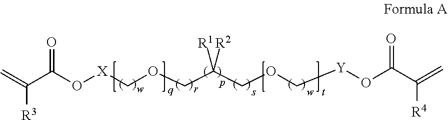
wherein:
R¹ is H or C₁-C₆ alkyl;
R² is H or 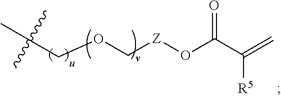
R³, R⁴, and R⁵ are independently H or CH₃;
X, Y, and Z are independently absent or C₁-C₆ alkylene group;
p is 0 or 1;
w at each occurrence is independently 1, 2, or 3;
q is 0 or an integer from 1-100;
t is 0 or an integer from 1-100;
r, s, u, and v are independently 0, 1, 2, 3, or 4;
with the proviso that q+t is no more than 100.

47. The composition of claim 45, wherein the ethylenically unsaturated UV curable monomer or oligomer further comprises a second monomer or oligomer comprising a second di- or tri-(meth)acrylate monomer or oligomer having a molecular weight less than about 4000 g/mol.

48. The composition of claim 45, wherein the first di- or tri-(meth)acrylate monomer or oligomer comprises 1,6-hexanediol diacrylate, ethoxylated trimethylolpropan-acrylic acid ester, polyethylene glycol diacrylate, or a combination of two or more thereof and the second di- or tri-(meth)acrylate monomer or oligomer comprises 2-propenoic acid-1,1′-(1,6-hexanediyl)ester, 1,6-hexanediol di-2-propenoate, 4-hydroxybutyl acrylate, 3,3,5-trimethyl cyclohexyl acrylate, 4-acrylolmorpholine, 3-acryloxy-2-hydroxypropoxypropyl terminated polydimethylsiloxane, 2-propenoic acid 1,4-butanediyl-bis[oxy(2-hydroxy-3,1-propanediyl)] ester, 4-(1,1-dimethylethyl)cyclohexyl acrylate, an oligomeric urethane acrylate, or a combination of two or more thereof.

49. The composition of claim 37, wherein the composition comprises about 5 wt % to about 30 wt % of the ethylenically unsaturated UV curable composition, based on the total composition.

50. The composition of claim 37, wherein the composition further comprises a photoinitiator, a formulation additive or a UV absorbing agent.

51. The composition of claim 50, wherein the formulation additive comprises urea-polyol-aliphatic copolymer, polypropoxy diethylmethylammonium chloride, alkoxylated polyethylenimine, polyethyleneimine, polyvinyl amine, benzyl pyridinium-3-carboxylate, quaternary ammonium compound, polyvinylpyrrolidone, vinylpyrrolidone/vinylimidazole copolymer, tetra-functional block copolymers based on poly(ethylene oxide) and poly(propylene oxide) with secondary alcohol terminal groups, tetra-functional triblock copolymers based on poly(ethylene oxide) and poly(propylene oxide) with primary alcohol terminal groups, polyoxyethylene-polyoxypropylene triblock copolymer with primary alcohol terminal groups, polyoxyethylene-polyoxypropylene triblock copolymer with secondary alcohol terminal groups, mixture of aliphatic dicarboxylic acids, sodium polyacrylate aqueous solution, acrylic copolymer emulsion in water, acrylic block copolymer, high molecular weight unsaturated carboxylic acid, modified hydrogenated castor oil, fatty acid modified polyester, alcohol alkoxylate, or combination of two or more thereof.

52. The composition of claim 50, wherein the composition comprises greater than 0 and less than about 0.2 wt % of the UV absorbing agent, based on the total composition and the UV light depth of penetration during cure between about 0.1 mm and about 0.2 mm.

53. A ceramic photoresin composition comprising:
about 5 wt % to about 30 wt % of an ethylenically unsaturated UV curable composition;
about 70 wt % to about 95 wt % of a ceramic composition;
about 0.05 wt % to about 5 wt % of a photoinitiator;
about 0.2 wt % to about 3 wt % of a formulation additive; and
greater than 0 and less than about 0.2 wt % of an UV absorbing agent;
wherein:
the composition has a viscosity of about 3500 cP to about 5000 cP;
the ethylenically unsaturated UV curable composition comprises 1,6-hexanediol diacrylate, ethoxylated trimethylolpropan-acrylic acid ester, polyethylene glycol diacrylate, 2-propenoic acid-1,1′-(1,6-hexanediyl)ester, 1,6-hexanediol di-2-propenoate, 4-hydroxybutyl acrylate, 3,3,5-trimethyl cyclohexyl acrylate, 4-acrylolmorpholine, 3-acryloxy-2-hydroxypropoxypropyl terminated polydimethylsiloxane, 2-propenoic acid 1,4-butanediyl-bis[oxy(2-hydroxy-3,1-propanediyl)] ester, 4-(1,1-dimethylethyl)cyclohexyl acrylate, an oligomeric urethane acrylate, or a combination of two or more thereof; and
ceramic composition comprises silica and optionally zircon, alumina, zirconia, mullite, mineral materials, yittria, or a combination two or more thereof; and the silica comprises silica particles having a particle size of less than about 100 μm.

54. A 3D printed article comprising the UV cured successive layers of the composition of claim 37.

55. A method for producing the composition of claim 37 comprising:
providing the ethylenically unsaturated UV curable composition and optionally the photoinitiator, the formulation additive, and/or the UV absorbing agent to provide a first mixture;
mixing and heating the first mixture;
optionally adding a photoinitiator to the first mixture;
adding the ceramic composition to the first mixture to provide a second mixture;
mixing the second mixture.

56. A method for producing a three-dimensional printed article comprising applying successive layers of one or more of the UV curable compositions of claim 37 to fabricate a three-dimensional article; and irradiating the successive layers with UV irradiation.
